(19) United States
(12) Patent Application Publication
(10) Pub. No.: US 2023/0254674 A1
(43) Pub. Date: Aug. 10, 2023

(54) MOBILITY SERVICE PROVIDING METHOD, MOBILITY SERVICE PROVIDING SYSTEM, SERVER DEVICE, EDGE DEVICE, AND NON-TRANSITORY COMPUTER READABLE STORAGE MEDIUM

(71) Applicant: DENSO CORPORATION, Kariya-city (JP)

(72) Inventors: Motoki SATO, Kariya-city (JP); Yohsuke SATOH, Kariya-city (JP)

(21) Appl. No.: 18/160,324

(22) Filed: Jan. 27, 2023

(30) Foreign Application Priority Data
Feb. 10, 2022 (JP) 2022-019687

(51) Int. Cl. H04W 4/46; H04W 8/02

(52) U.S. Cl. CPC H04W 4/46; H04W 8/02

(57) ABSTRACT

A cloud server distributes a request application to an edge-equipped vehicle. The edge device executes the request application using the resource of the edge-equipped vehicle, and notifies the cloud server of resource information regarding the resource usage status related to the execution of the request application. The cloud server generates first compensation information to be charged to the user who requests the request application and second compensation information to be paid to the owner of the edge-equipped vehicle according to the resource information.

### CROSS REFERENCE TO RELATED APPLICATIONS

The present application claims the benefit of priority from Japanese Patent Application No. 2022-019687 filed on Feb. 10, 2022. The entire disclosure of the above application is incorporated herein by reference.

### TECHNICAL FIELD

The present disclosure relates to a technology for effectively using a resource of a connected car.

### BACKGROUND

A conceivable technique teaches a technique of connecting a vehicle to a network and uploading and downloading various data between the vehicle and the network.

### SUMMARY

According to an example, a cloud server distributes a request application to an edge-equipped vehicle. The edge device executes the request application using the resource of the edge-equipped vehicle, and notifies the cloud server of resource information regarding the resource usage status related to the execution of the request application. The cloud server generates first compensation information to be charged to the user who requests the request application and second compensation information to be paid to the owner of the edge-equipped vehicle according to the resource information.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a configuration of a mobility IoT system;

FIG. 2 is a block diagram showing a configuration of an edge device;

FIG. 3 is a block diagram showing the configuration of a cloud server;

FIG. 4 is a functional block diagram of an edge device and a cloud server;

FIG. 5 is a state transition diagram of lending base status;

FIG. 6 is a state transition diagram of a processing status;

FIG. 7 is a sequence diagram showing operations of an application monitoring main module;

FIG. 8 is a sequence diagram showing operations of an application management thread;

FIG. 9 is a sequence diagram showing operations of an application management thread;

FIG. 10 is a diagram showing a list illustrating the data structure of the processing status;

FIG. 11 is a diagram showing a table illustrating the data structure of a user profile;

FIG. 12 is a diagram showing a list illustrating the data structure of a layout requirement specification profile;

FIG. 13 is a diagram showing a list illustrating the data structure of a certificate;

FIG. 14 is a diagram showing a table illustrating the data structure of CE status;

FIG. 15 is an explanatory diagram showing an outline of the operation of the mobility IoT system in a normal situation;

FIG. 16 is an explanatory diagram showing an outline of the operation of the mobility IoT system when applying for application registration;

FIG. 17 is an explanatory diagram showing an outline of the operation of the mobility IoT system during operation of the request application;

FIG. 18 is an explanatory diagram showing an outline of the operation of the mobility IoT system when a complete type application ends normally;

FIG. 19 is an explanatory diagram showing an outline of the operation of the mobility IoT system when a cloud-side interruption request is made;

FIG. 20 is an explanatory diagram showing an outline of the operation of the mobility IoT system when a vehicle-side interruption request is made;

FIG. 21 is an explanatory diagram showing an outline of the operation of the mobility IoT system when an anomaly processing is detected;

FIG. 22 is an explanatory diagram showing an outline of the operation of the mobility IoT system regarding the billing request of the post billing; and

FIG. 23 is an explanatory diagram showing an outline of the operation of the mobility IoT system regarding the billing request of the pre-billing.

### DETAILED DESCRIPTION

With the spread of mobility services, it has become possible to access vehicles via networks and implement various applications using the functions and resources of vehicles. For example, it is conceivable that there are service providers who wish to obtain the result of executing an application on a desired vehicle.

One aspect of the present embodiments provides technology related to mobility services that allow vehicles connected to a network to execute various applications.

A mobility service providing method according to one aspect of the present embodiments provides a service for causing an edge-equipped vehicle, which is a vehicle equipped with an edge device that communicates with a server device, to execute a request application, which is an application registered in the server device. The server device determines an edge-equipped vehicle that satisfies the distribution requirements set in association with the request application as a distribution target vehicle, and distributes the request application to the edge device mounted in the distribution target vehicle. The edge device executes the request application distributed from the server device using resources provided in the edge-equipped vehicle, and notifies the server device of resource information regarding the resource usage status related to the execution of the request application. The server device, according to the resource information notified from the edge device, generates the first compensation information to be charged to the user who requests the processing of the request application and the second compensation information to be charged to the owner of the edge-equipped vehicle that provided the resource.

According to such a method, it is possible to cause the edge-equipped vehicle to execute the request application by using resources provided in the edge-equipped vehicle. In addition, according to such a method, it is possible to request compensation from both the user of the resource and the provider of the resource. Therefore, for example, a new business can be provided such that the needs of vehicle owners who want to make a profit by providing the resources of edge-equipped vehicles match the needs of program developers who want to use the processing power of the resources even if they charge a fee.

A mobility service providing system according to one aspect of the embodiments includes a server device and an edge device. The edge device is mounted on the vehicle and communicates with the server device. The edge device also includes an application execution unit and a status notification unit. A vehicle equipped with the edge device is defined as the edge-equipped vehicle, and the application execution unit is configured to execute the request application, which is an application distributed from the server device, using resources provided in the edge-equipped vehicle. The status notification unit is configured such that an edge-equipped vehicle, which is a vehicle on which the edge device is mounted, grasps resource information regarding the resource usage status related to execution of the request application, and notifies the server device of the resource information. The server device includes an application distribution unit and an application billing unit. The application distribution unit is configured to determine, as a distribution target vehicle, an edge-equipped vehicle that satisfies distribution requirements set in association with the request application, and to distribute the request application to the edge device mounted on the distribution target vehicle. The application billing unit, according to the resource information notified from the edge device, generates the first compensation information to be charged to the user who requests the processing of the request application and the second compensation information to be charged to the owner of the edge-equipped vehicle that provided the resource.

According to such a configuration, it is possible to obtain the same effects as those of the mobility service providing method described above.

A server device according to one aspect of the embodiments includes an application distribution unit and an application billing unit, and provides the mobility service providing system described above together with the edge device.

According to such a configuration, the mobility service providing system described above can be constructed together with the edge device.

An edge device according to one aspect of the embodiments includes an application execution unit and a status notification unit, and constitutes the mobility service providing system described above together with a server device. According to such a configuration, the mobility service providing system described above can be constructed together with the server device.

A program according to one aspect of the embodiments causes the computer included in the server device described above to function as an application distribution unit and an application billing unit. According to such a program, each function of the server device can be implemented.

Embodiments of the present disclosure will be described below with reference to the drawings.

### 1. Overall Configuration

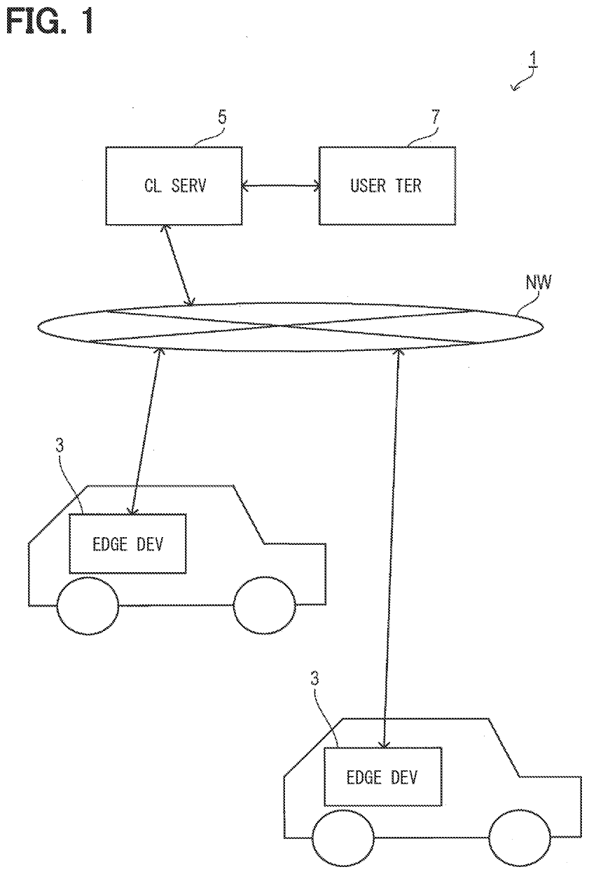

A mobility IoT system 1 shown in FIG. 1 includes a plurality of edge devices 3, a cloud server 5 and an user terminal 7. IoT is an abbreviation for Internet of Things. The mobility IoT system 1 corresponds to the mobility service providing system in the embodiments, the method implemented in the mobility IoT system 1 corresponds to the mobility service providing method in the embodiments, and the cloud server 5 corresponds to the server device in the embodiments.

The edge device 3 is mounted on the vehicle and functions as an edge computer that couples between the vehicle and the cloud server 5 to collect vehicle information and perform vehicle control.

The cloud server 5 manages a database that accumulates vehicle information provided from the edge device 3 by communicating with the edge device 3 via the wide area communication network NW, and provides the user of an interface to access the database and the edge device 3. The user is also called a third party, and include application developers, application users, operation system users, and the like.

A user terminal 7 is a terminal device used by a user of the mobility IoT system 1. The user terminal 7 accesses the cloud server 5 using a graphic user interface (hereinafter referred to as GUI) provided by the cloud server 5.

Here, in the mobility IoT system 1, by lending resources of a vehicle equipped with an edge device 3 (hereinafter referred to as an edge-equipped vehicle) to an applicant, a configuration of a service for executing various programs on the edge-equipped vehicle will be explained. The resources refer to computing resources of the CPU, equipment such as cameras and various sensors mounted on the vehicle. A method of providing various services to an edge-equipped vehicle corresponds to the program execution service providing method in the embodiments.

### 2. Edge Device

[2-1. Hardware Configuration]

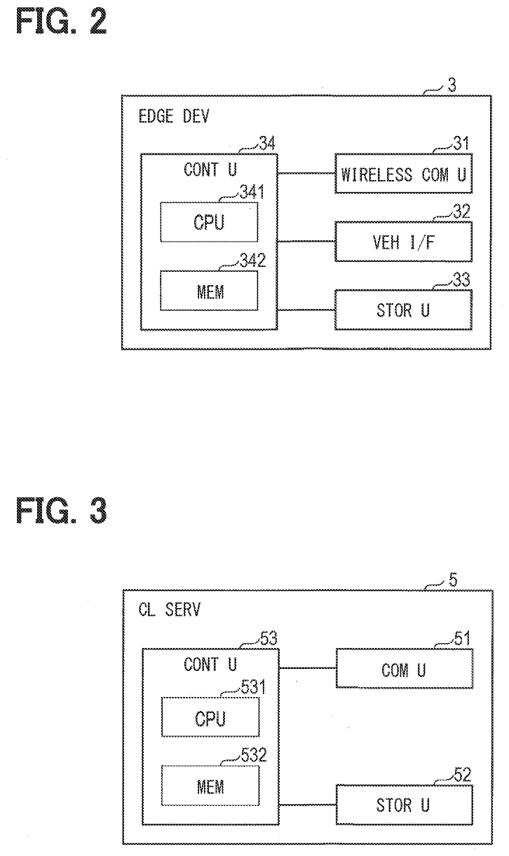

As shown in FIG. 2, the edge device 3 includes a wireless communication unit 31, a vehicle IF unit 32, a storage unit 33, and a control unit 34.

The wireless communication unit 31 communicates with the cloud server 5 by wireless communication via the wide area communication network NW.

The vehicle I/F unit 32 is connected to various in-vehicle devices via an in-vehicle network or the like of the edge-equipped vehicle, and acquires various types of information from the in-vehicle devices. The in-vehicle device connected to the vehicle I/F unit 32 may include an exterior device that is added later as well as a device that is originally mounted on the edge-equipped vehicle.

The storage unit 33 stores vehicle information and the like acquired via the vehicle IF unit 32 and to be uploaded to the cloud server 5.

The control unit 34 includes a CPU 341 and a semiconductor memory (hereinafter referred to as memory) 342 such as ROM and RAM.

[2-2. Functional Configuration]

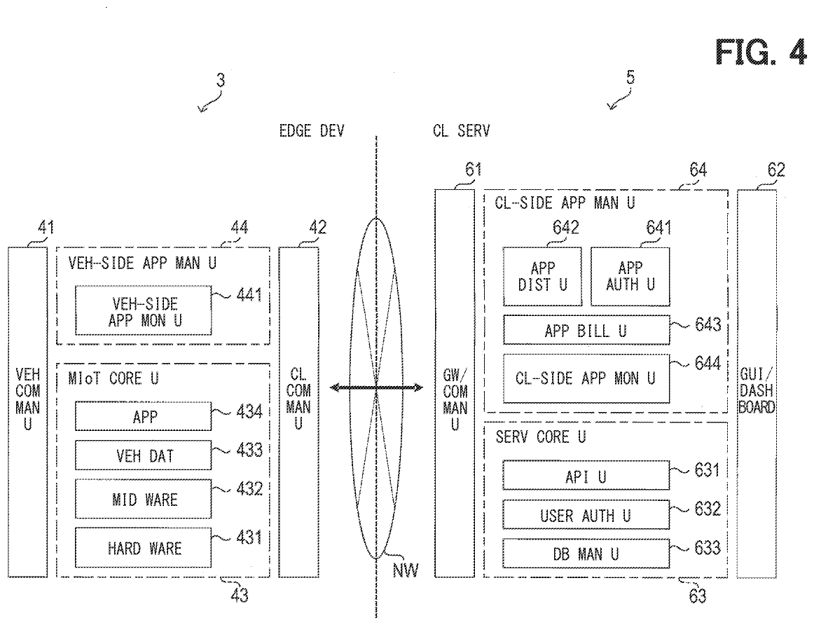

The edge device 3 includes a vehicle communication management unit 41, a cloud communication management unit 42, an MIoT core unit 43, and a vehicle-side application management unit 44, as shown in FIG. 4. The functions of each of these units 41 to 44 are implemented by the CPU 341 executing programs stored in the memory 342.

The vehicle communication management unit 41 manages communication with an in-vehicle device executed via the vehicle IF unit 32. The in-vehicle device includes standard equipment such as electronic control units and sensors that are normally mounted in the vehicle, as well as external equipment that is optionally mounted to the vehicle afterwards.

The cloud communication management unit 42 manages communication with the cloud server 5 performed via the wireless communication unit 31.

The MIoT core unit 43 provides a function as an edge computer that couples between the cloud and the vehicle. Specifically, the MIoT core unit 43 has a function of collecting vehicle information of a vehicle equipped with the edge device 3 (hereinafter referred to as an edge-equipped vehicle) and uploading it to the cloud server 5, and a function for controlling the edge-equipped vehicle according to instructions from the cloud server 5. The MIoT core unit 43 also provides a function of executing applications downloaded from the cloud server 5. That is, the MIoT core unit 43 corresponds to the application execution unit in the embodiments.

The MIoT core unit 43 includes hardware 431, middleware 432, vehicle information database (hereinafter referred to as vehicle DB) 433, and application 434.

The hardware 431 includes an in-vehicle device connected via the vehicle IF unit 32 in addition to equipment provided in the edge device 3 such as the CPU 341 and the memory 342.

The middle ware 432 abstracts the hardware 431 and includes basic software for providing various services necessary for executing application programs 434, and drivers for supporting special processing that cannot be standardized. The basic software includes an operating system (hereinafter referred to as an OS), a hardware abstraction layer (hereinafter referred to as a HAL), and the like. The drivers include a resource status (i.e., RS) acquisition driver that acquires the status of the hardware 431. The OS kernel includes a system call processing unit M8 that processes system calls from the application 434.

The vehicle DB 433 is a database that stores vehicle information collected via the vehicle communication management unit 41 and provided to the cloud server 5, and is disposed in the storage unit 33.

The application 434 is a program that accesses the hardware 431 using functions provided by the middleware 432 and implements various functions. The application 434 includes an application distributed from the cloud server 5 or the like as well as an application installed from the beginning. The applications to be distributed include applications requested for processing by users (hereinafter referred to as request applications). A plurality of applications 434 may be arranged at the same time.

The request applications include non-vehicle jobs and vehicle jobs. The vehicle job is a vehicle-related job that is to be computed by the vehicle, and is meaningless if computed by a computer other than the vehicle. The non-vehicle job is a job other than a vehicle job.

Also, the request application includes a resident type and a complete type. A resident type request application is an application that repeatedly processes routine jobs such as monitoring and data collection during a specified period. The resident type request application is recovered to the cloud server 5 (that is, deleted from the edge device 3) when an interruption request is received from the cloud server 5 or when anomaly processing is detected during execution of the request application. Specifically, the resident type request application may execute vehicle sensor monitoring, road information collection, weather information collection, information collection when a vehicle accident occurs, and the like.

A complete-type request application is an application that processes an irregular job whose process ends when the calculation result is output. The complete type request application is recovered by the cloud server 5 not only when an interruption request from the cloud server 5 is detected and when anomaly processing is detected, but also when the process ends normally, similar to the resident type request application. Specifically, the complete type request application may be an application that executes simulation, large-scale parallel calculation such as mathematical and scientific calculation, high-speed calculation, or requires special-purpose calculation library.

The vehicle-side application management unit 44 includes a vehicle-side application monitor unit 441. The vehicle-side application monitor unit 441 provides a function of managing request applications.

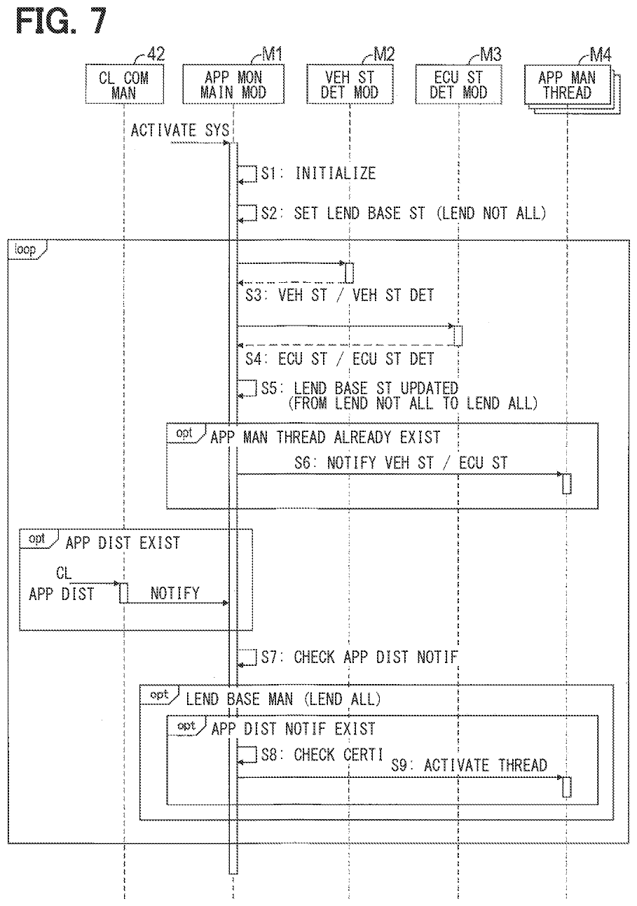

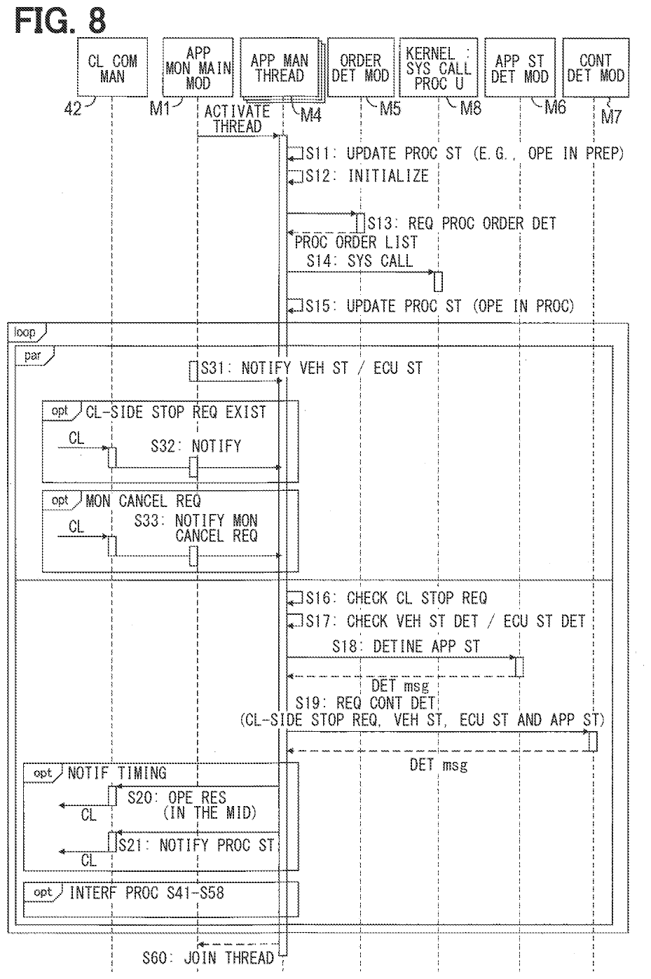

The vehicle-side application monitor unit 441 includes, as shown in FIG. 7, an application monitor main module M1, a vehicle state determination module M2, an ECU state determination module M3, and an application management thread M4. The application management thread M4 is provided for each installed request application. Furthermore, as shown in FIG. 8, the vehicle-side application monitor unit 441 includes an order determination module M5, an application state determination module M6, and a continuation determination module M7.

The application monitor main module (hereinafter referred to as main module) M1 updates the lending base status according to the determination results from the vehicle state determination module M2 and the ECU state determination module M3. The main module M1 notifies the application management thread M4 associated with the request application serving as the notification destination of these determination results and the notification from the cloud server 5 received via the cloud communication management unit 42.

Also, the main module M1 intervenes exchanges including processing status, metadata, calculation results, and various notifications between each application management thread M4 and the cloud server 5.

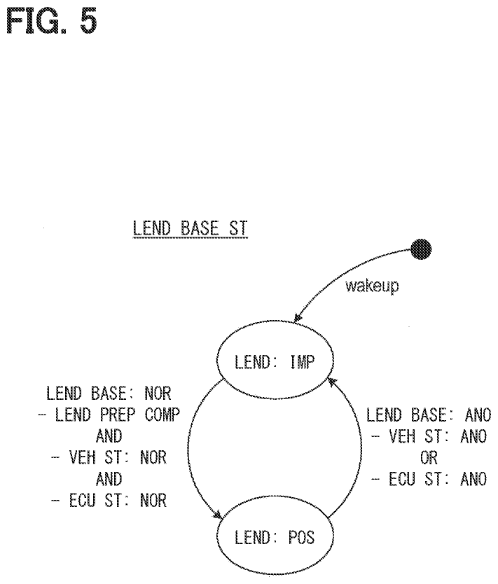

The lending base status updated by the main module M1 has two states of “lending not allowed” and “lending allowed”, as shown in FIG. 5. The lending base status transitions according to the vehicle state obtained from the vehicle state determination module M2 and the ECU state obtained from the ECU state determination module M3.

When the lending base status is “lending not allowed”, it indicates that the edge-equipped vehicle cannot accept and execute the request application. When the lending base status is “lending allowed”, it indicates that the edge-equipped vehicle can accept and execute the request application.

Here, the edge device 3 has a wake-up state in which all functions can be provided, and a sleep state in which the functions that can be provided are limited. The vehicle-side application monitor unit 441 functions in the wakeup state, and the lending base status immediately after transitioning to the wakeup state becomes “lending not allowed”.

When the lending base status is “lending not allowed”, the main module M1 updates the lending base status to “lending allowed” under a condition that the determination result of the vehicle state and the determination result of the ECU state are both normal after completing the lending preparation. When the lending base status is “lending allowed”, the main module M1 updates the lending base status to “lending not allowed” under a condition that at least one of the determination result of the vehicle state and the determination result of the ECU state is anomaly.

The vehicle state determination module M2 determines whether the vehicle state is “normal” or “anomaly”.

The vehicle condition determination module M2 determines “anomaly” when maintenance of the vehicle needs to be prioritized over the provision of the lending base, and determines “normal” when the lending base can be provided.

The vehicle information referred to by the vehicle state determination module M2 includes the voltage of the vehicle battery device from which the edge device 3 is supplied with power, presence or absence of access conflict with external devices, and presence or absence of activation of the advanced driving assist systems (hereinafter, ADAS) including automatic braking and obstacle avoidance. The vehicle information referred to by the vehicle state determination module M2 may include the detection value of an acceleration sensor for detecting sudden braking and collision, the position of a shift lever for detecting a parking state, the presence or absence of issuance of a diagnostic trouble code (hereinafter referred to as DTC).

The determination logic used in the vehicle state determination module M2 may be selected for the purpose of detecting the possibility that the lending of the edge device 3 hinders the safe driving of the vehicle, and may be designed with various design concept for each vehicle.

In one example of the determination logic used in the vehicle state determination module M2, the condition for determining the vehicle state as “normal” includes that the position of the shift lever of the subject vehicle is “a parking position (i.e., P)”. In this case, since the condition for lending the resource is limited to the stopped vehicle, it is possible to prevent the request application from hindering the execution of the process that affects safety or the like while the vehicle is running.

In one example of the determination logic used in the vehicle state determination module M2, the condition for determining the vehicle state as “anomaly” may include the voltage of the vehicle battery falling below a certain threshold. In this case, it is possible to prevent the inability to maintain main functions of the vehicle such as engine start and ECU due to vehicle battery consumption because of resource lending. Also, in this case, resource lending is not limited to stopped vehicles, but can also be applied to running vehicles.

In one example of the determination logic used in the vehicle state determination module M2, the condition for determining the state of the vehicle as “normal” may include that the ADAS function is not activated in the subject vehicle. In this case, in situations where highly urgent vehicle control such as automatic braking and obstacle avoidance is executed, the highly urgent vehicle control can be prioritized over the processing of the request application.

The determination logic used in the vehicle state determination module M2 may be designed by the automobile manufacturer or by the user. Also, the function of the vehicle state determination module M2 may not only differ from vehicle to vehicle or user to user, but also be arranged on the cloud server 5 side although, in general, the module M2 is arranged on the edge device 3 side since it is necessary to respond immediately to vehicle state changes.

The ECU state determination module M3 determines whether the state of the edge device 3 is “normal” or “anomaly” and determines the “load status” of the edge device 3. The “load status” may be expressed in two stages of “high load” and “low load”, or may be expressed in multiple stages of three or more stages.

The ECU state determination module M3 determines that the state of the edge device 3 is “anomaly” when there is a possibility that the maintenance of the edge device 3 or the safe operation of the subject vehicle will be hindered, and that the state of the edge device 3 is “normal” when it does not correspond to the above situation.

The determination result of the “load status” may be used, for example, to adjust the load balance between the edge devices 3 when the cloud server 5 selects a distribution target vehicle that is an edge-equipped vehicle to which the request application is to be distributed.

Since the function of the ECU state determination module M3 is determined by the performance of the edge device 3, the module M3 is, in general, arranged on the edge device 3 side, alternatively, it may be arranged on the cloud server 5 side.

The information referred to by the ECU state determination module M3 may include the voltage of the auxiliary battery, the temperature of the central processing unit and the graphics processing unit, the operating frequency of the core, the presence or absence of an anomaly signal from the external device connected to the edge device 3, and the like. The information referred to by the ECU state determination module M3 may include information for the purpose of maintenance management, such as software updates for the OS, middleware, hardware drivers, and security software provided in the edge device 3, and software updates for other in-vehicle ECUs.

The determination logic used in the ECU state determination module M3 may be designed based on the detection of the possibility that the lending of resources managed by the edge device 3 hinders the safe driving of the vehicle, and designed with various design concepts for each type of the vehicles.

As an example of the determination logic used in the ECU state determination module M3, the condition for determination of “anomaly” may include detection of temperature anomaly in the central processing unit or the graphics processing unit. In this case, heat generation of hardware included in the edge device 3, and thus vehicle heat generation, can be suppressed.

In one example of the determination logic used in the ECU state determination module M3, the conditions for determination as “anomaly” may include a situation in which the edge device 3 cannot provide resources, such as during execution of maintenance management processing such as software updates.

In one example of the determination logic used in the ECU state determination module M3, the conditions for determining as “anomaly” may include a situation of the resource where there is a possibility that the normal processing of the request application cannot be completed due to detection of an anomaly in the operating frequency of the core or an anomaly in an external device.

The application management thread M4 executes the scheduling of allocation of CPU processing time using the order determination module M5 based on the priority set for the request application. The application management thread M4 also outputs a command to the system call processing unit M8 of the kernel so that the request application is executed according to the scheduling result. Further, the application management thread M4 determines whether to continue the request application using the continuation determination module M7 based on the vehicle state and the ECU state notified from the main module M1, the cloud side stop request notified from the cloud server 5, and the determination result of the application state determination module M6. The application management thread M4 updates the processing status according to the determination result of the continuation determination, and executes processing according to the processing status. The processing status indicates the state of the processing of the request application, and is set for each request application.

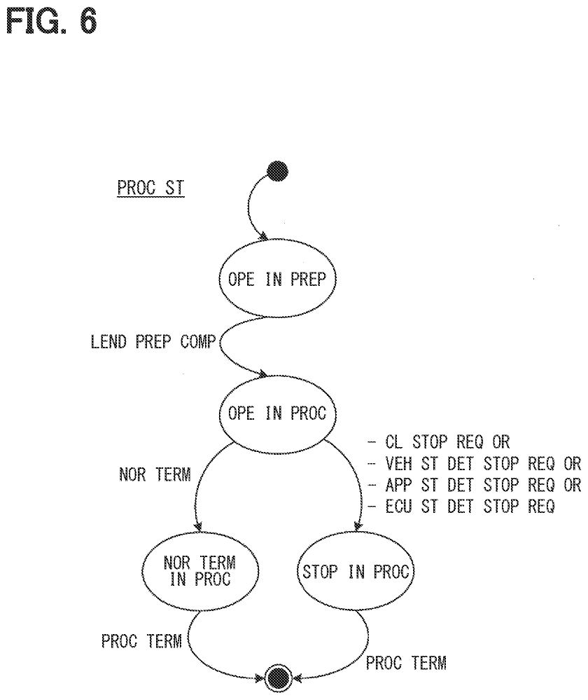

As shown in FIG. 6, the processing status has six states of “operation in preparation”, “operation in processing”, “normal termination in processing”, “stop process 1”, “stop process 2”, and “stop process 3”. Note that “stop process 1”, “stop process 2”, and “stop process 3” are also collectively referred to as “stop in processing”. All of them are stop processes, but the stop processes 1 to 3 are distinguished according to the transition conditions to the stop process.

When the processing status is “operation in preparation”, the application management thread M4 executes the operation preparation process including a pre-process such as initialization of a application monitor process and verification of certificates, and updates the processing status to the “operation in processing”.

When the processing status is “operation in processing”, the application management thread M4 executes the operation process. Furthermore, when the continuation determination module M7 determines that the request application has terminated normally during the “operation in processing”, the application management thread M4 updates the processing status to “normal termination in processing”. Further, when the application management thread M4 receives a cloud stop request from the cloud server 5 during the “operation in processing”, the thread M4 updates the processing status to “stop process 1”. The application management thread M4 updates the processing status to the “stop process 2” when the application state determination module M6 determines that the request application is in an anomaly state during the “operation in processing”. The application management thread M4 updates the processing status to “stop process 3” when the main module M1 notifies of an anomaly in the vehicle state or the ECU state during the “operation in processing”.

When the processing status is “normal termination in processing”, the application management thread M4 executes normal termination process, and when the normal termination process is completed, the thread M4 updates the processing status to “operation in preparation”.

When the processing status is the “stop process 1”, the application management thread M4 executes the first stop process, which is the stop processing at the time of normal termination, and updates the processing status to the “operation in preparation” after terminating the first stop process.

When the processing status is the “stop process 2”, the application management thread M4 executes the second stop process of interrupting the process in a restartable state, and updates the processing status to the “operation in preparation” after terminating the second stop process.

When the processing status is the “stop process 3”, the application management thread M4 executes the third stop process, which is the stop processing at the time of anomaly termination, and updates the processing status to the “operation in preparation” after terminating the third stop process.

[2-3. Application Monitor Main Module Processing]

Processing executed by the main module M1 will be described below with reference to the state transition diagram of the lending base status shown in FIG. 5 and the sequence diagram of FIG. 7.

After completing the initialization (at S1) by activating the system, the main module M1 sets the lending base status to the “lending stop” (at S2). Thereafter, the main module M1 acquires the determination result of the vehicle state from the vehicle state determination module M2 by polling (at S3), and acquires the determination result of the ECU state from the ECU state determination module M3 (at S4).

The main module M1 updates the lending base status in accordance with the combination of the acquired vehicle state determination result and the acquired ECU state determination result (at S5). Specifically, when both the “vehicle state” as the determination result of the vehicle state determination module M2 and the “ECU state” as the determination result of the ECU state determination module M3 are “normal”, the main module M1 updates the lending base status to the “lending allowed”. Further, the main module M1 updates the lending base status to the “lending not allowed” when at least one of the “vehicle status” and the “ECU status” is “anomaly”. It should be noted that the determination result of the “load status” by the ECU state determination module M3 is not used for updating the lending base status. The “load status” is notified to the cloud server 5, and is used on the cloud server 5 side, for example, when determining a distribution target vehicle that is an edge-equipped vehicle to which the request application is distributed from the viewpoint of load balance.

When even one application management thread M4 exists, the main module M1 notifies each application management thread M4 of the acquired “vehicle state” and “ECU state” (at S6).

When the lending base status is the “lending allowed”, the main module M1 checks whether an application distribution notification indicating that the request application has been distributed from the cloud server 5 via the cloud communication management unit 42 (at S7).

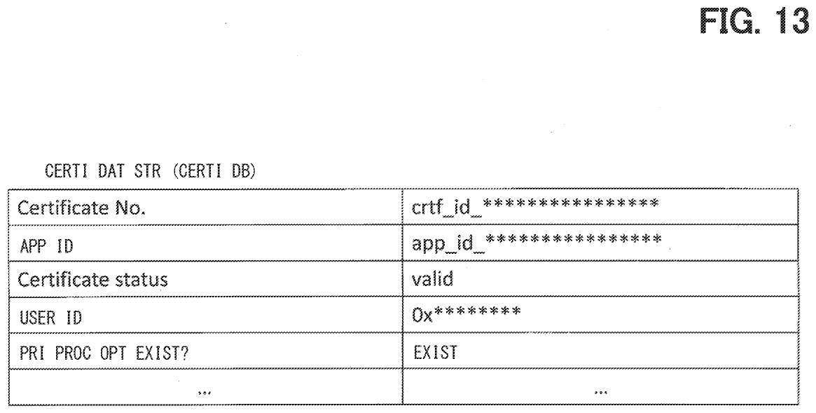

When the main module M1 confirms that the application delivery notification has been received, the main module M1 performs authentication using the certificate attached to the request application (S8). When the certificate authentication is successful, the main module M1 activates an application management thread that manages the execution of the request application associated with the application distribution notification (at S9). The certificate has the contents shown in FIG. 13, and the details thereof will be described later.

[2-4. Application Management Thread Processing]

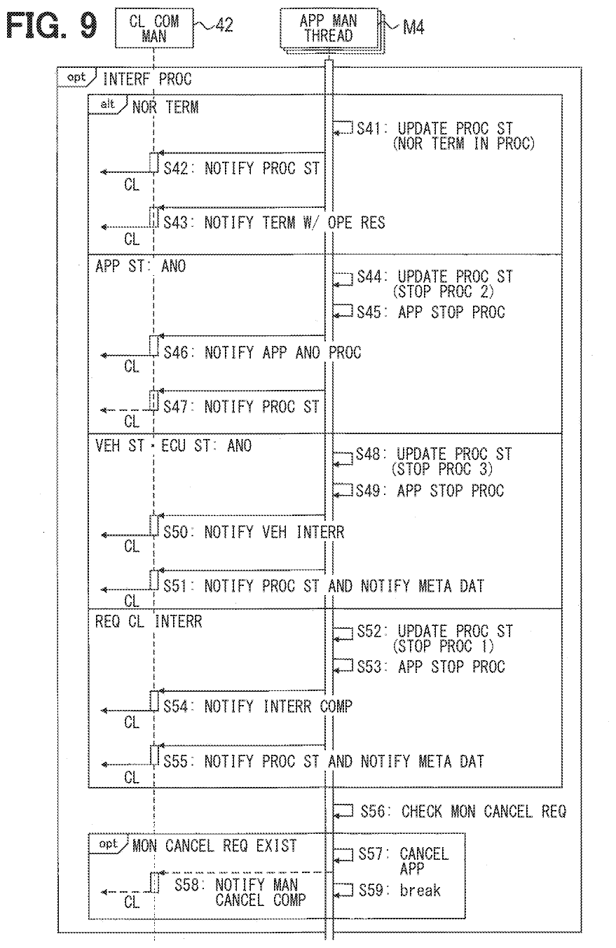

Processing executed by the application management thread M4 will be described with reference to the state transition diagram of the processing status shown in FIG. 6 and the sequence diagrams shown in FIGS. 8 and 9.

When activated by the main module M1, the application management thread M4 sets the processing status of the request application to the “operation in preparation” (at S11). The application management thread M4 executes an initialization process for applying the distributed request application to the subject vehicle so that it can be executed using the function provided by the MIoT core unit 43 (at S12).

The application management thread M4 requests the order determination module M5 to determine the processing order, thereby obtaining an order list representing the schedule of CPU processing time allocation (at S13). The order determination module M5 sets the order list so that more processing time than usual is allocated when the priority option item of the certificate is set to “with priority”.

The application management thread M4 issues a system call so as to allocate CPU processing time to each application including the request application according to the acquired order list (at S14). The system call is issued to the system call processing unit M8 in the OS kernel included in the middleware 432. After that, the request application is activated by the OS and executes a predetermined operation.

After activating the request application, the application management thread M4 updates the processing status to “operation in processing” (at S15).

In other words, the processes of S12 to S14 are calculation preparation processes for preparing an execution environment for the request application distributed from the cloud server 5.

When the processing of the request application is started, the application management thread M4 repeats the processing of S16 to S21 shown below and the interference processing that intervenes in the execution of the request application.

The application management thread M4 checks whether or not the cloud-side interruption request notification has been received from the cloud server 5 (at S16). The application management thread M4 also checks the “vehicle state” and the “ECU state” notified from the main module M1 (at S17).

The application management thread M4 inquires of the application state determination module M6 about the status of the request application (hereinafter referred to as the application status) associated with the application management thread M4, and acquires a determination message indicating the determination result of the application status (at S18).

The application state determination module M6 determines whether the application status is “normal,” “anomaly,” or “normally terminated.” The application state determination module M6 determines “normal” when the operation processing based on the request application is progressing normally, determines “anomaly” when suspicious behavior is observed in the operation processing, and determines “normally terminated” when the operation processing ends normally.

The “normal” determination conditions may include that the CPU usage rate by the request application is smaller than a reference value, that the memory usage rate is smaller than the reference value, and that the communication buffer usage rate is smaller than the reference value. In addition, the determination conditions for “normal” may include that neither memory leak nor unauthorized access to the outside of the permitted memory area has occurred, that there is no access to an external equipment that is not designated, that access to the information not permitted by the vehicle owner has not been occurred, that there is no unauthorized data transmission to the outside, and the like.

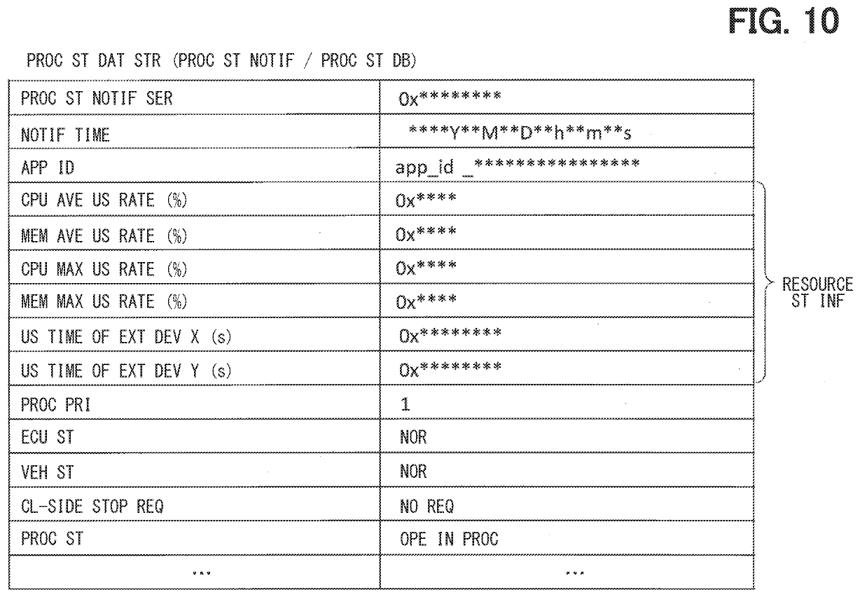

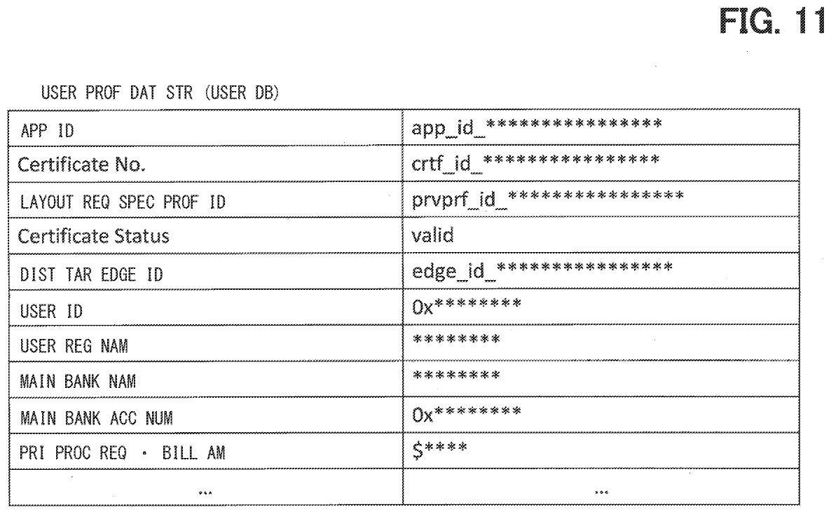

The application state determination module M6 may acquire resource status information to be referred to for determination of the application status by requesting an RS acquisition driver included in the middleware 432. As shown in FIG. 10, the resource status information may include an average CPU usage rate, an average memory usage rate, the maximum CPU usage rate, the maximum memory usage rate, usage time for each external device, and the like. The resource status information corresponds to resource information in the embodiments.

The CPU average usage rate and the maximum CPU usage rate are the average usage rate and the maximum usage rate of the CPU that executes the request application. The memory average usage rate and the maximum memory usage rate are the average usage rate and the maximum usage rate of the memory used during execution of the request application. The external device usage time indicates the time during which the external device is used by the request application, and when multiple external devices are used, it is recorded for each external device. The resource status information may further include accessed memory addresses, communication volume, communication buffer usage rate, and the like.

The application management thread M4 inputs information such as presence/absence of a cloud-side stop request, the vehicle state, the ECU state, and the application state to the continuation determination module M7, and acquires the determination message indicating the continuation determination result related to the continuation of the application from the continuation determination module M7 (at S19).

If the application status is anomaly, the continuation determination module M7 sets the continuation determination result to “anomaly application status”. If at least one of the “vehicle state” and the “ECU state” is anomaly, the continuation determination module M7 sets the continuation determination result to “anomaly vehicle state/ECU state”. If there is a cloud side interruption request, the continuation determination module M7 sets the continuation determination result to the “cloud side interruption request”.

The continuation determination module M7 sets the continuation determination result to “normal termination” when the requested application is of the complete type and the application status is “normal termination.” If none of the above-described continuation determination results apply, the continuation determination module M7 sets the continuation determination result to “continuation.”

Note that the processing (at S31) for notifying the application management thread M4 of the “vehicle state” and the “ECU state” acquired by the main module M1 in its own processing, and the check determination processing S16 to S19 in the application management thread M4 are repeatedly executed in parallel. Further, when the main module M1 receives a cloud stop request or a monitoring cancellation request from the cloud server 5 via the cloud communication management unit 42, it executes processing S32 and S33 for transmitting these requests to each application management thread M4.

If the request application as a management target is of the complete type or the resident type and it is necessary to periodically transmit the calculation result to the cloud server 5, the application management thread M4 sends the calculation result to the cloud server 5 via the cloud communication management unit 42 at an arbitrary event timing (at S20). Also, the application management thread M4 transmits a processing status notification to the cloud server 5 via the cloud communication management unit 42 at an arbitrary event timing for the purpose of updating the processing status held by the cloud server 5 (at S21).

As shown in FIG. 10, the processing status notification may include the serial number, the notification time, the application ID, the processing priority, the vehicle state, the ECU state, the cloud side stop request, the processing status, and the like in addition to resource status information. The serial number is a numerical number that uniquely identifies a processing status notification to be sent for a request application. The notification time is the time when the processing status notification is notified. The application ID is an identification number given to the request application. The processing priority is a value assigned to the request application by the user of the distribution source. The vehicle state, the ECU state, and the cloud side stop request are information notified from the main module M1 to the application management thread M4. The processing status is a status updated by the application management thread M4.

According to the continuation determination result of the continuation determination module M7, the application management thread M4 repeatedly executes the monitoring process shown in S16 to S21 when the continuation determination result is “continuation”. If the continuation determination result is other than “continuation”, the application management thread M4 executes the interference process described below, and then notifies the main module M1 of the termination of the thread and terminates the process.

As shown in FIG. 9, the application management thread M4 executes different interference processes according to the continuation determination result.

When the continuation determination result is “normally terminated”, the application management thread M4 updates the processing status to “normally terminated” (at S41), and transmits a processing status notification to the cloud server 5 (at S42). Also, the application management thread M4 transmits the calculation result of the request application to the cloud server 5 together with the termination notification (at S43).

When the application management thread M4 determines that the continuation determination is “anomaly application state”, it updates the processing status to “stop processing/stop process 2” (at S44), and executes processing to stop the request application (at S45). Thereafter, the application management thread M4 transmits an application anomaly processing notification indicating that processing has been stopped due to “anomaly application state” to the cloud server 5 (at S46), and also transmits a processing status notification to the cloud server 5 (at S47).

When the application management thread M4 determines that the continuation determination is “anomaly vehicle state/ECU state”, it updates the processing status to the “stop processing/stop process 3” (at S48), and executes processing to stop the request application (at S49). After that, the application management thread M4 transmits to the cloud server 5 a vehicle-side interruption notification indicating that the processing has been stopped due to “anomaly vehicle state/ECU state” (at S50), and also sends a processing status notification and metadata notification to the cloud server 5 (at S51).

When the application management thread M4 determines that the continuation determination is “cloud side interruption request”, it updates the processing status to “stop processing/stop process 1” (at S52), and executes processing to stop the request application (at S53). After that, the application management thread M4 transmits an interruption completion notification indicating that the processing has been stopped due to the “cloud side interruption request” to the cloud server 5 (at S54), and also transmits a processing status notification and a metadata notification to the cloud server 5 (at S55).

The metadata sent by the metadata notification may include a restart data group necessary for restarting the request application from the interrupted position, a diagnostic data group necessary for identifying the cause of anomaly or high load, and the like. The restart data group and the diagnostic data group may include an execution file, various calculation management parameter sets at the time of interruption, physical parameter sets at the time of interruption, and the like.

The application management thread M4 checks whether or not there is a monitoring cancellation request from the cloud server 5 (at S56). When the application management thread confirms that there is a monitoring cancellation request, it deletes the request application (at S57), transmits a management cancellation completion notification to the cloud server 5 (at S58), and stops processing.

### 3. Cloud Server

[3-1. Hardware Configuration]

As shown in FIG. 3, the cloud server 5 includes a communication unit 51, a storage unit 52, and a control unit 53.

The communication unit 51 communicates with the edge device 3 and the user terminal 7 via the wide area communication network NW.

The storage unit 52 is used as a database for accumulating vehicle information acquired via the communication unit 51 and uploaded from each of the plurality of edge devices 3.

The control unit 53 includes a CPU 531 and a semiconductor memory (hereinafter referred to as memory) 532 such as ROM and RAM.

[3-2. Functional Configuration]

When the cloud server 5 is shown in blocks by function, as shown in FIG. 4, the cloud server 5 incudes a GW/communication management unit 61, a GUI/dashboard 62, a service core unit 63 and a cloud side application management unit 64. The functions of each of these units 61 to 64 are implemented by the CPU 531 executing programs stored in the memory 532.

The GW/communication management unit 61 generates the shadow DB as a database for storing the vehicle information to be uploaded through communication with the edge device 3 for each vehicle by connecting the vehicle position and the like at which the vehicle information is acquired.

The GUI/dashboard 62 provides a graphic interface used when accessing the cloud server 5 via the user terminal 7.

The service core unit 63 includes an API unit 631, a user authentication unit 632, and a database management unit (hereinafter referred to as DB management unit) 633.

The API unit 631 provides an application development API and the like for users who develop applications using the mobility IoT system 1. API is an abbreviation for Application Programming Interface. The API unit 631 provides an API for accessing the shadow DB to acquire vehicle information, an API for accessing the edge device 3 to acquire information directly from the vehicle on which the edge device 3 is installed, an API for controlling the vehicle on which the edge device 3 is installed, and the like.

The user authentication unit 632 provides a function of authenticating a user who uses the API unit 631.

The DB management unit 633 provides a function of realizing access to the shadow DB in response to requests from the API unit 631.

The cloud side application management unit 64 includes an application authentication unit 641, an application distribution unit 642, an application billing unit 643, and a cloud side application monitoring unit 644.

The application authentication unit 641 provides a function of authenticating the safety of applications developed by users. The application authentication unit 641 issues a certificate to an authenticated application.

The application authentication is performed by evaluating evaluation items such as power consumption, occurrence of excessive load on external devices, excessive memory access and consumption, core system interference, and past unauthorized use history of users. If the evaluation results of these evaluation items are all within the acceptable range, a certificate will be issued.

The application authentication unit 641 stores and manages the user profile provided by the user, the layout specification request profile, and the certificate issued for the authenticated application in the user DB, the layout specification DB, and the certificate DB, respectively, at the time of application authentication request. A user DB, a layout specification DB, and a certificate DB are provided in the storage unit 52, for example. The application registered by being authenticated by the application authentication unit 641 becomes the request application distributed to the edge-equipped vehicle. The application authentication unit 641 manages not only registration of the request application but also update, deletion, and the like of the request application.

The application authentication unit 641 registers, updates, and deletes the request application at the request of the user who creates the request application. In addition, the application authentication unit 641 forcibly deprives of the certificate of the request application that has caused an illegal operation at the distribution target and cancels the registration.

A user profile is information for linking a request application and a user. As shown in FIG. 11, the user profile may include an application ID, the certificate number, a layout requirement specification profile ID, a certificate status, a distribution target edge ID, an user ID, an user registration name, a transaction financial institution name, a transaction financial Institutional account number, a billing amount at the time of priority processing request, and the like.

The application ID is an identification number uniquely assigned to the request application, which is an authenticated application. The certificate number is the numerical number of the certificate issued to the request application (hereinafter referred to as the particular application) identified by the application ID. The layout requirement specification profile ID is an identification number assigned to the layout requirement specification profile associated with the particular application. The certificate status indicates whether the certificate specified by the certificate number is valid or invalid. The distribution target edge ID is an identification number assigned to the edge device 3 that is the distribution target of the particular application. The user ID is an identification number given to the user who requests registration of the particular application. The user registration name is the registered name of the user identified by the user ID. The transaction financial institution name and the transaction financial account number are the financial institution name and the account number used for billing and payment to the user identified by the user ID. The billing amount at the time of requesting priority processing is the charge amount when the user requests priority processing for execution of the request application.

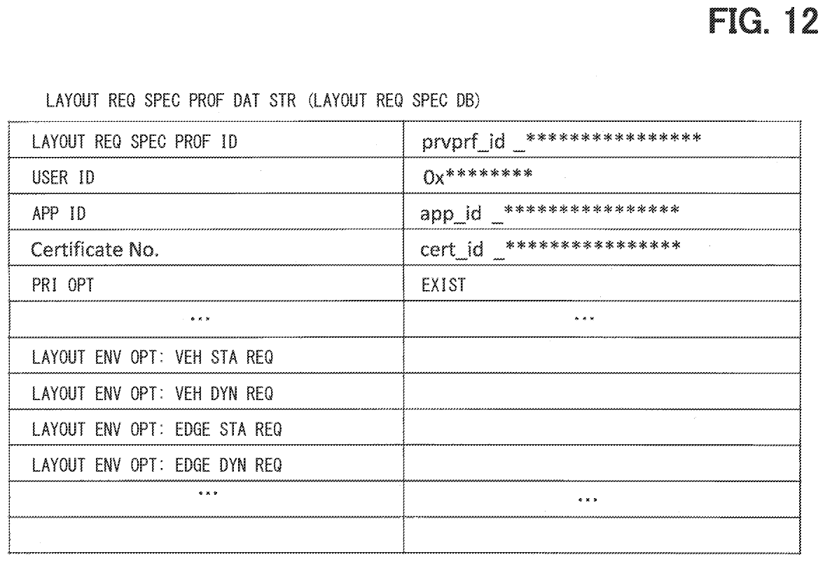

The layout requirement specification profile is information indicating distribution requirements, which are requirements for the distribution target of the request application. The layout requirement specification profile, as shown in FIG. 12, may include a layout requirement specification profile ID, a user ID, an application ID, a certificate number, a priority option, a layout environment option, and the like.

The layout requirement specification profile ID, an user ID, an application ID, and the certificate number are explained in the user profile, so the explanation is omitted.

Here, the application ID indicated in the user profile is the identification number of the request application (that is, the particular application) linked to the layout requirement specification profile identified by the layout requirement specification profile ID. The user ID and the certificate number are information that specifies a user and a certificate number that are linked to the particular application. The priority option is information indicating whether or not the use of the function of setting the priority of the processing of the particular application is permitted.

The layout environment option indicates requirements and the like necessary for execution of the particular application. The layout environment option may include vehicle static requirements and vehicle dynamic requirements, which are distribution requirements for edge-equipped vehicles, and edge static requirements and edge dynamic requirements, which are distribution requirements for the edge device 3.

The vehicle static requirements may include basic vehicle information such as VIN, a vehicle type, year/model, exterior equipment, retrofits, optional equipment, and fuel type. The VIN stands for Vehicle Identification.

It is an abbreviation for Number, and it is a number that can identify the vehicle manufacturer, vehicle type, model, and model year. In addition to these vehicle base information, the vehicle static requirements may include vehicle usage history information and owner information. The vehicle usage history information is information such as history of accidents, cause of accidents, years of ownership, past owners, and the like. The owner information is information such as the age and sex of the vehicle owner, the number of years of ownership, the industry/type of business of the owner corporation, the number of vehicles owned by the owner corporation, and the like.

The vehicle dynamic requirements may include vehicle interior environment information, vehicle exterior environment information, vehicle state information, device/function usage information, occupant information, time-series data information, and the like. The vehicle environment information is, for example, information such as vehicle interior temperature, humidity, smoking, smell, vehicle interior dirt, load weight, and vehicle interior tools. The external environmental information includes, for example, temperature, rainfall, humidity, atmospheric pressure, heavy fog, snowfall, wind pressure, road surface conditions, surrounding vehicle information, surrounding pedestrian information, construction work, road paint lines/road signs, animal traffic, outside air pollution (for example, fire, factory accident, chemical contamination), presence or absence of accident, arranged vehicle currency, arranged person passage, emergency vehicle passage, submergence, flying objects, vehicle location (e.g. country, prefecture, highway, urban area, industrial area, suburban area, underground ground, specific area), and the like. The vehicle state information includes, for example, parked/stopped vehicle, IG state, anomaly state, remaining fuel, vehicle speed, acceleration/deceleration, shift lever position, accelerator opening, engine speed, yaw rate, and brake air pressure. The usage information of the devices and functions is information such as wipers, turn signals, lamps, seat position, door opening/closing, locks, acceleration/deceleration, sudden steering wheel operation/sudden steering, frequency of use of automatic parking function, cruise control, autopilot, frequency of horn use, frequency of use of an air conditioner, window open/close rate, shift lever operation, ADAS function, light usage frequency/time, and the like. The passenger information includes, for example, the number of passengers, age of passengers, sex of passengers, physical condition of passengers, psychological state of passengers, boarding rate, boarding time, continuous boarding time, operating rate, length of operating time, passenger getting on/off time/pattern, usage frequency of in-vehicle media, usage details of in-vehicle media, driving characteristics, and the like. The time-series data information is, for example, time-series data of the parameters described above.

The edge static requirements may include edge basic information such as RAM/ROM installed capacity, CPU type/clock/core number, operating frequency, installed application, ROM usage capacity, installed external device, and the like.

The edge dynamic requirements may include edge state information such as RAM usage capacity, CPU utilization rate, edge state anomaly, lending base status and processing status.

The user can specify the distribution target of the request application using such distribution requirements.

The certificate is used to guarantee the request application to the distribution target of the request application. The certificate may include the certificate number, the application ID, the certificate status, the user ID, the priority options, and the like, as shown in FIG. 13.

Here, the application ID indicated in the certificate is the identification number of the request application (that is, the particular application) linked to the certificate specified by the certificate number.

The certificate number, the certificate status, the user ID, and the priority option are explained in the user profile and the layout requirement specification profile, so the explanation is omitted.

The application distribution unit 642 distributes the request application, which is an application authenticated by the application authentication unit 641 and given a certificate, to pre-registered edge-equipped vehicles.

The application distribution unit 642 selects a distribution target by referring to the user profile DB, the layout requirement specification profile DB, the certificate DB, the CE status DB, and the processing status DB.

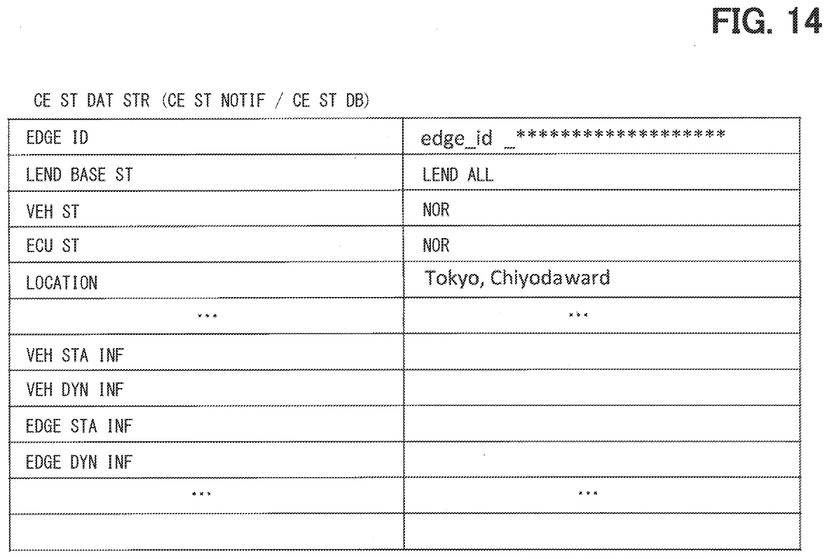

The CE status is information indicating the static status and dynamic status of the edge-equipped vehicle and the edge device 3. CE is an abbreviation for car and edge. The CE status is generated by the edge device 3 and sent to the cloud server 5 using the CE status notification. As shown in FIG. 14, the CE status may include information such as the edge ID, the lending base status, the vehicle status, the ECU status, the location, the vehicle static information, the vehicle dynamic information, the edge static information, and the edge dynamic information. The static information is information that does not change over time, and the dynamic information is information that changes over time. A shadow DB provided in the GW/communication management unit 61 may be used as the CE status DB. The CE status DB stores an individual CE status for each vehicle on which the edge device 3 is mounted. Note that the CE status DB corresponds to the individual vehicle database in the embodiments.

The edge ID is identification information that identifies the edge device 3. The lending base status indicates the lending base status of the edge device 3 (hereinafter referred to as the target edge) identified by the edge ID. The vehicle state determination indicates the determination result of the vehicle state determination module M2. The ECU state determination indicates the determination result of the ECU state determination module M3. The location is information indicating the position of the particular vehicle that generates the CE status notification. The vehicle static information, the vehicle dynamic information, the edge static information, the edge dynamic information correspond to the vehicle static requirement, the vehicle dynamic requirement, the edge static requirement, the edge dynamic requirement in the layout requirement specification profile, respectively, and relate to the unique information equipped in the particular vehicle. The vehicle static information, the vehicle dynamic information, the edge static information, and the edge dynamic information may not always necessarily include all of the information indicated as the vehicle static requirement, the vehicle dynamic requirement, the edge static requirement, and the edge dynamic requirement.

When the application distribution unit 642 receives an application distribution request from the application authentication unit 641, the application distribution unit 642 refers to the distribution requirement specification DB and extracts the distribution requirement (that is, operation specifications, presence/absence of external devices, and the like) in association with the request application as the distribution object. The application distribution unit 642 further refers to the CE status DB to determine a distribution target from edge-equipped vehicles whose lending base status is “lending allowed” and which satisfies the extracted distribution requirements, and distributes the request application to the specified distribution target. When a plurality of edge-equipped vehicles are extracted, the distribution target may be determined according to an algorithm for determining the distribution target based on the margin of operation specifications, information on past billing amounts, specifications of external devices, and the like.

When the request application is a non-vehicle job, the distribution requirements may be, for example, the edge static requirements or the edge dynamic requirements. In this case, the application distribution unit 642 refers to the CE status DB, and extracts an edge-equipped vehicle of which the installed ROM/RAM capacity and the CPU operating rate indicated in the static edge information and the dynamic edge information satisfy the distribution requirements, and then determines the distribution target from among the extracted edge-equipped vehicles.

When the request application is a vehicle job, for example, the vehicle static requirements, the vehicle dynamic requirements, the edge static requirements, and the edge dynamic requirements may be used as the distribution requirements. Specific examples 1 to 6 in this case are illustrated below.

The specific example 1 is a case where the user is an OEM/exterior product developer who wants to grasp the usage status/usage method of an in-vehicle product developed in-house and use it for product development, evaluation, and improvement. In this case, for example, the vehicle type, the number of passengers, the driving road, and the like are set as the distribution requirements. The application distribution unit 642 refers to the CE status DB and checks the basic vehicle information, the owner information, the in-vehicle environment information, the exterior environment information, the vehicle state, the device/function usage information, the passenger information, and the time-series data information, and determines the edge-equipped vehicle that satisfies the distribution requirements as the distribution target. One example is a case in which an in-vehicle camera developer is a user and distributes an application that monitors the usage status of their developed in-vehicle camera to the edge-equipped vehicle.

The specific example 2 is a case where the user is an application/external device developer who needs a survey test, a large-scale test, or a pre-mass production field test but cannot prepare an environment. In this case, for example, external equipment, weather, area, and the like are set as the distribution requirements. The application distribution unit 642 refers to the CE status DB and checks the basic vehicle information, the usage history information, the owner information, the in-vehicle environment information, the exterior environment information, the vehicle state, the device/function usage information, the passenger information, and the time-series data information, and determines the edge-equipped vehicle that satisfies the distribution requirements as the distribution target. One example is a case where a software developer is a user and distributes an application for developing a road environment learning algorithm for autonomous driving to an edge-equipped vehicle. The software developer needs to prepare environments on a large scale that allow various combinations of the above information groups in order to increase the intensity of learning.

The specific example 3 is a case where the MaaS provider is an user who collects dynamic and static information related to a vehicle type, an industry field type, driving environment, a region, an owner, occupants, device usage method, and the like, and converts the collected information into big data that is stratified and processed according to certain criteria, and handles the big data. In this case, for example, the weather at the time of travelling, the presence or absence of high-speed travelling, the travel area, a specific type of industry, the customer base of passengers, and the like are set as the distribution requirements. The application distribution unit 642 refers to the CE status DB and checks the basic vehicle information, the usage history information, the owner information, the in-vehicle environment information, the exterior environment information, the vehicle state, the device/function usage information, the passenger information, and the time-series data information, and determines the edge-equipped vehicle that satisfies the distribution requirements as the distribution target. As an example, there is a case where a taxi dispatch service provider serves as a user and distributes an application for surveying taxi operation areas and passenger boarding points to taxi vehicles equipped with the edge device 3. In addition, there are cases in which an application for investigating the psychological state of drivers who frequently accelerate and decelerate, a health management application for bus passengers, a health management application for highway vehicle drivers, and the like are distributed to edge-equipped vehicles.

The specific example 4 is a case where the user is an application developer who needs to develop applications and collect data for rare vehicles, special vehicles, and vehicles equipped with special exterior equipment. In this case, for example, the presence or absence of a motor for an elevating arm of a large heavy machine or a brake device of a large transport vehicle is set as a distribution requirement. The application distribution unit 642 refers to the CE status DB and checks the basic vehicle information, the owner information, the in-vehicle environment information, the vehicle state, the device/function usage information, and the time-series data information, and determines the edge-equipped vehicle that satisfies the distribution requirements as the distribution target. As an example, there is a case where a brake control ECU developer serves as an user and distribute a braking deterioration monitoring application for a large truck to an edge-equipped vehicle.

The specific example 5 is a case where the user is a public institution, a MaaS business operator, a news agency, a facility maintenance business operator who needs dynamic data outside the vehicle such as road information collection, weather information collection, construction information, accident detection, and the like. In this case, for example, an exterior camera, an image recognition function for weather, people, objects, events, and road surface conditions, a hygrometer, presence or absence of wiper operation, and the like are set as the distribution requirements. The application distribution unit 642 refers to the CE status DB, checks the vehicle interior environment information, the vehicle exterior environment information, and the time-series data information, and determines edge-equipped vehicles that satisfy the distribution requirements as distribution targets. As an example, there is a case where a map distribution service provider becomes a user and distributes an application for automatic map generation algorithm development to an edge-equipped vehicle. There may be an other case where an application for an on-demand car cleaning and on-demand refueling services, and local weather large-scale sampling applications for the purpose of improving the accuracy of weather forecasts are distributed to the edge-equipped vehicle.

The specific example 6 is a case where the user is an investigative agency or a detective agent who wants to track a traffic-related or non-traffic-related incident, a vehicle involved in an accident, or a person. In this case, for example, a vehicle exterior camera, image recognition functions for weather, people, events, and the like are set as the distribution requirements. The application distribution unit 642 refers to the CE status DB, checks the vehicle exterior environment information, and the time-series data information, and determines edge-equipped vehicles that satisfy the distribution requirements as distribution targets. One example is a case where the police officer is a user and distributes an outside video collection application to edge-equipped vehicles.

The application distribution unit 642 also has a function of collecting and deleting the request application distributed to the edge device 3 in accordance with a deletion request from the user or a deletion request from the cloud side application monitoring unit 644.

The cloud-side application monitoring unit 644 updates the contents of the CE status DB and the processing status DB according to various notifications received from registered edge-equipped vehicles, and transmits instructions and the like to the edge device 3 as necessary. The cloud-side application monitoring unit 644 also outputs a request to the application authentication unit 641 and the application distribution unit 642 to delete the distributed request application, and outputs a settlement trigger to the application billing unit 643 according to the updated DB contents.

When a settlement trigger is input, the application billing unit 643 generates billing information representing billing to the user and margin information representing the compensation to be paid to the edge owner. The billing information and the margin information are generated based on resource usage logs shown in the processing status DB, user information shown in the user profile DB, and edge owner information. Note that the billing information corresponds to the first compensation information in the embodiments, and the margin information corresponds to the second compensation information in the embodiments.

The application billing unit 643 executes billing processing for the user and settlement processing for the edge owner based on the generated billing information. Note that the edge owner information may include an edge ID, a owner ID, a owner registration name, a bank account name, a bank account number, and the like. The edge ID is identification information that identifies the edge device 3. The owner ID is identification information given to the owner of the edge device 3 (hereinafter referred to as the particular edge device) identified by the edge ID. The owner registration name is the registered name of the owner identified by the owner ID. The transaction financial institution name and the transaction financial account number are the financial institution name and the account number used for billing and payment to the user identified by the owner ID.

The billing information may include basic billing according to resource usage amount and additional billing by using priority options. The processing priority that can be selected by the priority option may adopt a binary system of whether or not priority is given, a multi-level system, or arbitrary weighting. In this case, the amount of additional charge may be changed according to the type of priority option. The amount of the basic charge may be changed according to the time zone or the season according to the overall margin of resources in the entire system. For example, during late-night hours when the car usage rate is low, a low rate is set because there are spare resources, and a high rate is set during commuting hours when the car usage rate is high because there is no spare resource. Similarly, the charge may be set high during periods such as public holidays, consecutive holidays, and holidays when the car usage rate is high and there is no spare resource, and the charge may be set low during other periods.

Here, the charge to the user, that is, the compensation payment from the user may be other than money. For example, it may discount the price of the service provided by the user, issue a coupon, or provide free for contents, for example. Also, the compensation payment to the edge owner may be something other than money. For example, edge owners may get discounts on services they want to receive, coupons, points, electronic money, complimentary tickets, and right to obtain items such as desired content for free.

### 4. System Operation Overview

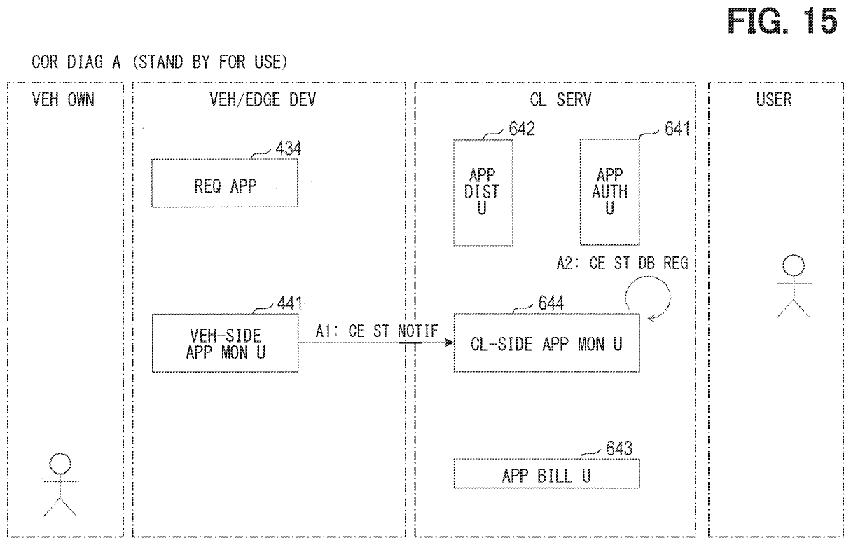

An overview of operations related to execution of a request application in the mobility IoT system 1 will be described with reference to FIGS. 15 to 21.

When the request application is not distributed to the edge-equipped vehicle, the vehicle-side application monitoring unit 441 periodically transmits a CE status notification to the cloud server 5 as shown in FIG. 15 (at A1). The content of the CE status notification is the same as the content of the CE status shown in FIG. 14.

Upon receiving the CE status notification, the cloud side application monitoring unit 644 updates the CE status DB according to the content of the CE status notification (at A2). That is, the CE status of the edge-equipped vehicle registered in the cloud server 5 is stored in the CE status DB, and the contents thereof are updated periodically.

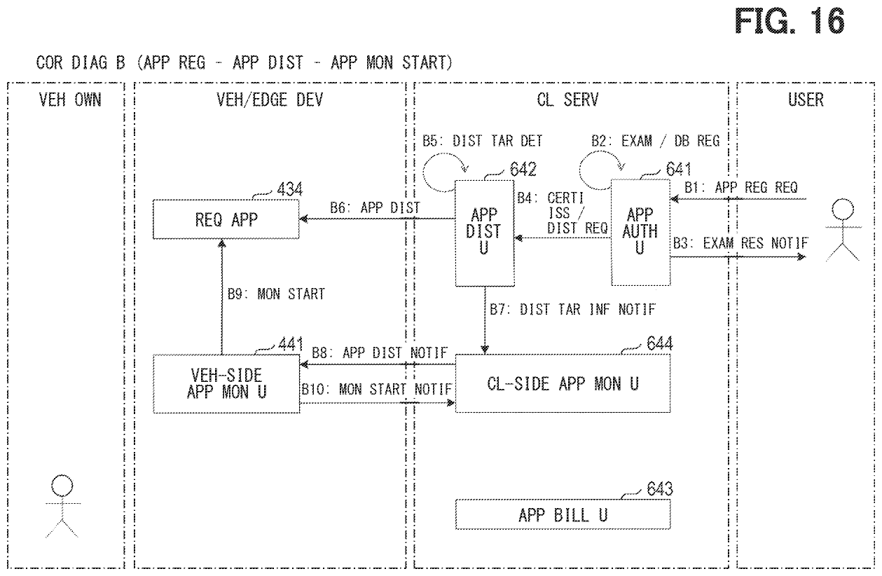

As shown in FIG. 16, when a user submits an application registration request to the cloud server 5 (at B1), the application authentication unit 641 examines the application. As a result of the examination, when the safety of the application is confirmed, the application authentication unit 641 issues a certificate and registers it in the certificate DB. An application for which a certificate has been issued is hereinafter referred to as a request application. Furthermore, the application authentication unit 641 registers the user profile and the layout requirement specification profile attached to the registration application in the user DB and the layout requirement specification DB (at B2). After that, the application authentication unit 641 notifies the user of the examination result (at B3), and makes a distribution request to the application distribution unit 642 (at B4).

The application distribution unit 642 that has received the distribution request determines a distribution target according to the layout requirement specification profile linked to the request application as the distribution request object, and the CE status of the edge-equipped vehicle stored in the CE status DB (at B5). Then, the application distribution unit 642 distributes the request application to the determined distribution target (at B6). Furthermore, the application distribution unit 642 provides the distribution target information including information for specifying the edge device 3 to which the request application is distributed, to the cloud side application monitoring unit 644 (at B7).

The cloud side application monitoring unit 644 transmits an application distribution notification to the edge device 3 of the distribution target according to the provided distribution target information (at B8).

Upon receiving the application distribution notification, the vehicle-side application monitoring unit 441 of the edge device 3 starts executing the distributed request application, and starts monitoring the execution status (that is, the presence or absence of anomaly processing, and the like) and resource usage status. (at B9). Furthermore, the vehicle-side application monitoring unit 441 transmits a monitoring start notification to the cloud server 5 (at B10).

Although not shown in the drawings, when a user requests the cloud server 5 to delete an application, the application authentication unit 641 deletes the user DB, the layout request specification DB, and the registered contents of the certificate DB, which are associated with the request application as a deletion target. Furthermore, the application authentication unit 641 notifies the user of a result notification indicating that the deletion has been completed.

Further, when a user requests the cloud server 5 to update an application, the application authentication unit 641 updates the user DB, the layout request specification DB, and the registered contents of the certificate DB linked to the request application as the update target. Furthermore, the application authentication unit 641 notifies the user of a result notification indicating that the update has been completed.

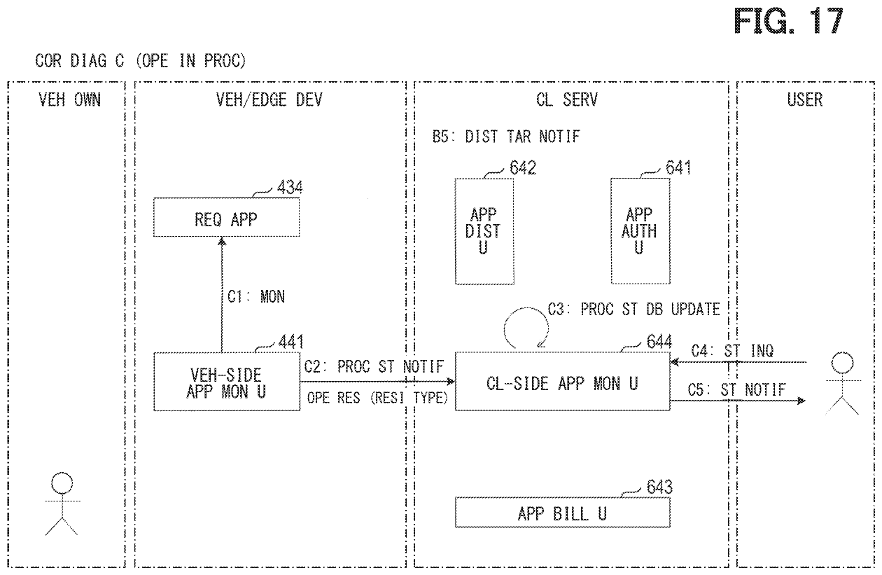

As shown in FIG. 17, the vehicle-side application monitoring unit 441 monitors the execution state and the resource usage state of the request application (at C1) while the processing status is “operation in processing”, and periodically transmits the contents recognized by the monitoring to the cloud server 5 via the processing status notification (C2). The contents of the processing status notification are the same as the processing status shown in FIG. 10. That is, the vehicle-side application monitoring unit 441 corresponds to the status notification unit. When the request application is a resident type application, the operation result is also transmitted at the timing specified by the request application.

Upon receiving the processing status notification, the cloud side application monitoring unit 644 updates the processing status DB according to the content of the processing status notification (at C3).

Also, when the user inquires about the processing status to the cloud server 5 (at C4), the cloud-side application monitoring unit 644 reads out the processing status of the application ID specified in the inquiry from the processing status DB, and notifies the user of the processing status. (at C5).

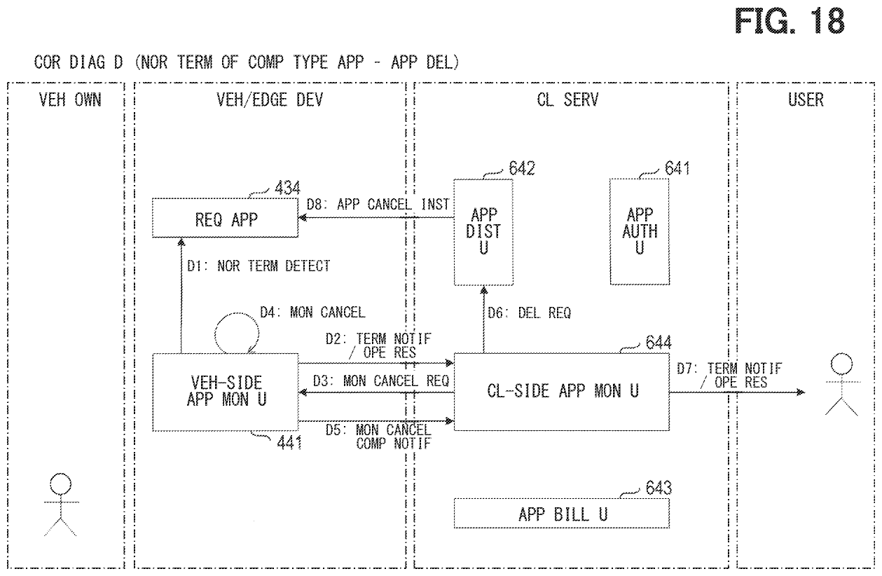

As shown in FIG. 18, when the vehicle-side application monitoring unit 441 detects the normal termination of the complete type request application when the processing status is “operation in processing” (at D1), the operation result of the request application is transmitted together with the termination notification to the cloud server 5 (at D2).

The cloud-side application monitoring unit 644 transmits a monitoring cancellation request to the edge device 3 that is the transmission source of the received termination notification (at D3).

The vehicle-side application monitoring unit 441 cancels the monitoring of the request application in accordance with the received monitoring cancellation request (at D4), and transmits a monitoring cancellation completion notification to the cloud server 5 (at D5).

The cloud-side application monitoring unit 644, which has received the monitoring cancellation completion notification, transmits an application deletion instruction to the application distribution unit 642 (at D6), and also transmits a termination notification, to which the operation result is attached, to the user (at D7).

The application distribution unit 642 transmits an application deletion instruction instructing the deletion of the request application to the edge device 3 as a distribution target to which the request application indicated in the deletion request is distributed (at D7).

Upon receiving the application deletion instruction, the MIoT core unit 43 of the edge device 3 deletes the instructed request application.

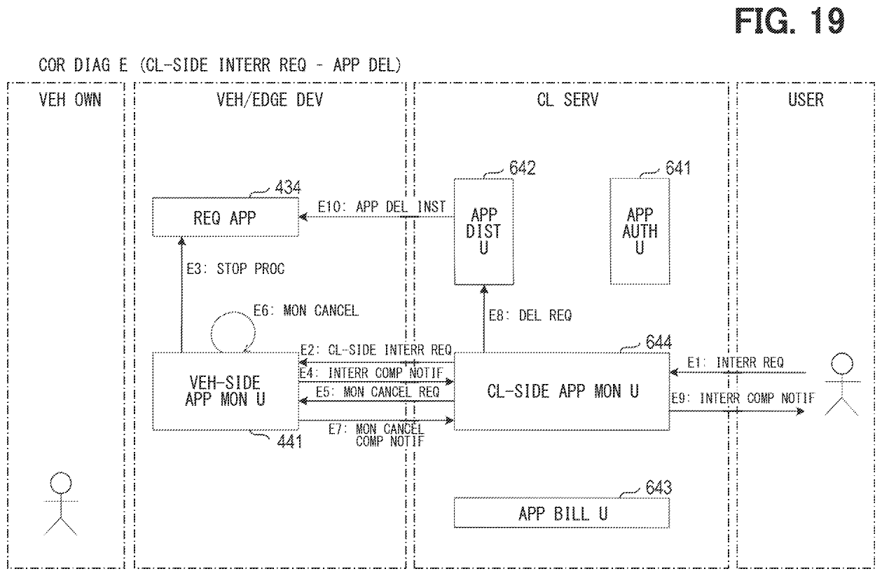

As shown in FIG. 19, when the cloud server 5 receives a request from a user to interrupt a request application whose processing status is “operation in processing” (at E1), the cloud-side application monitoring unit 644 specifies the edge device 3 as an interruption request target that is the distribution target of the request application, and transmits the cloud-side interruption request to the specified edge device 3 (at E2).

Upon receiving the cloud-side interruption request, the vehicle-side application monitoring unit 441 executes an interruption process to interrupt the request application in a state in which the request application can be restarted (at E3), and transmits an interruption completion notification together with metadata to the cloud server 5 (at E4).

Thereafter, similarly to D3 to D8 described above, transmission of a monitoring cancel request (at E5), execution of cancellation of monitoring (at E6), transmission of notification of completion of monitoring cancellation (at E7), a deletion request to the application distribution unit 642 (at E8), transmission of the interruption completion notification instead of the termination notification (at E9), transmission of the application deletion instruction (at E10), and deletion of the request application in the edge device 3 are performed.

When the user issues a restart instruction for the request application whose processing has been interrupted and has been collected in the cloud server 5, the distribution target is selected again, and the request application together with the metadata attached to the interruption completion notification is distributed to the selected distribution target. The edge device 3 to which the request application has been distributed together with the metadata restarts the processing of the request application from the interrupted point using the metadata.

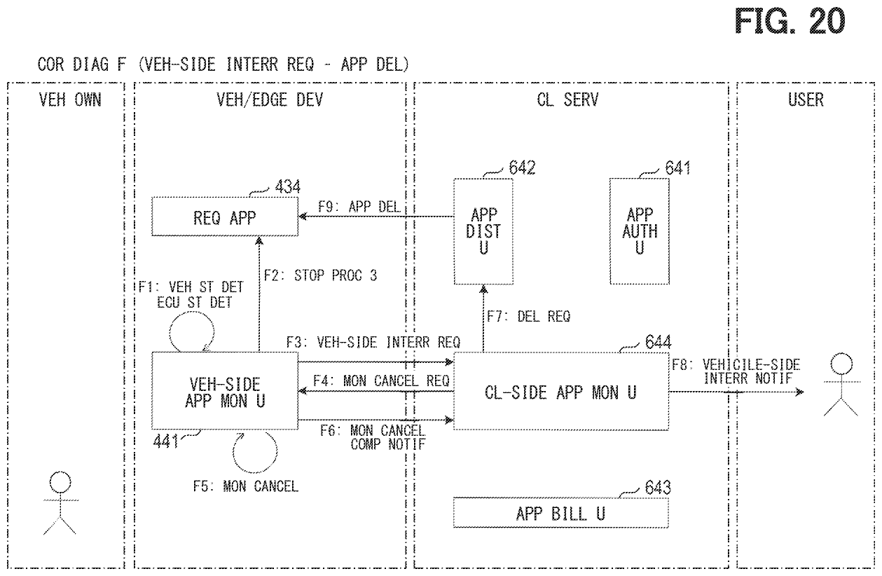

As shown in FIG. 20, when the vehicle-side application monitoring unit 441 detects the “anomaly of vehicle state/ECU state” as a continuation determination result for the request application whose processing status is “operation in processing” (at F1), the vehicle-side application monitoring unit 441 executes the third stop processing for stopping the request application (at F2). Further, the vehicle-side application monitoring unit 441 transmits a vehicle-side interruption notification to the cloud server 5 together with the metadata (at F3).

Thereafter, similarly to D3 to D8 described above, transmission of a monitoring cancel request (at F4), execution of cancellation of monitoring (at F5), transmission of notification of completion of monitoring cancellation (at F6), a deletion request to the application distribution unit 642 (at F7), transmission of the vehicle side interruption notification instead of the termination notification (at F8), transmission of the application deletion instruction (at F9), and deletion of the request application in the edge device 3 are performed.

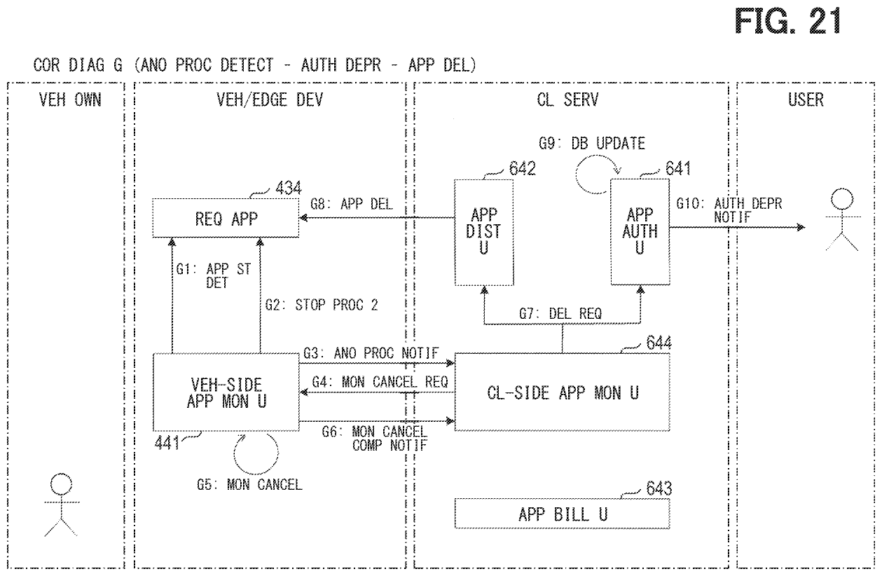

As shown in FIG. 21, when the vehicle-side application monitoring unit 441 detects the “anomaly of application state” as a continuation determination result for the request application whose processing status is “operation in processing” (at G1), the vehicle-side application monitoring unit 441 executes the second stop processing for stopping the request application (at G2). Furthermore, the vehicle-side application monitoring unit 441 transmits an anomaly processing notification to the cloud server 5 together with the metadata (at G3).

Thereafter, similarly to D3 to D5 described above, transmission of a request for canceling monitoring (at G4), execution of canceling monitoring (at G5), and transmission of completion notification of canceling monitoring (at G6) are performed.

After that, the cloud-side application monitoring unit 644 transmits a deletion request of the request application, distributed to the edge device 3 that is the transmission source of the anomaly processing notification, to the application distribution unit 642 and the application authentication unit 641 (at G7).

The application distribution unit 642 transmits an application deletion instruction instructing the deletion of the request application to the edge device 3 as a distribution target to which the request application indicated in the deletion request is distributed (at G8). Upon receiving the application deletion instruction, the MIoT core unit 43 of the edge device 3 deletes the instructed request application.

In response to the deletion request, the application authentication unit 641 updates the user DB and the like so that the certificate linked to the request application as the deletion request target becomes invalid (at G9). Furthermore, the application authentication unit 641 transmits to the user an authentication deprivation notification indicating that the authentication of the request application in which the anomaly process has occurred is deprived (at G10).

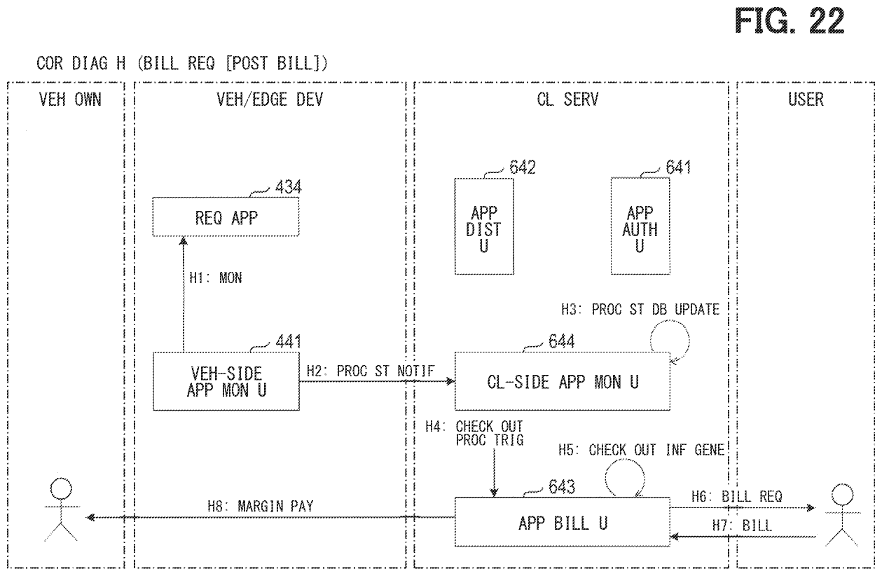

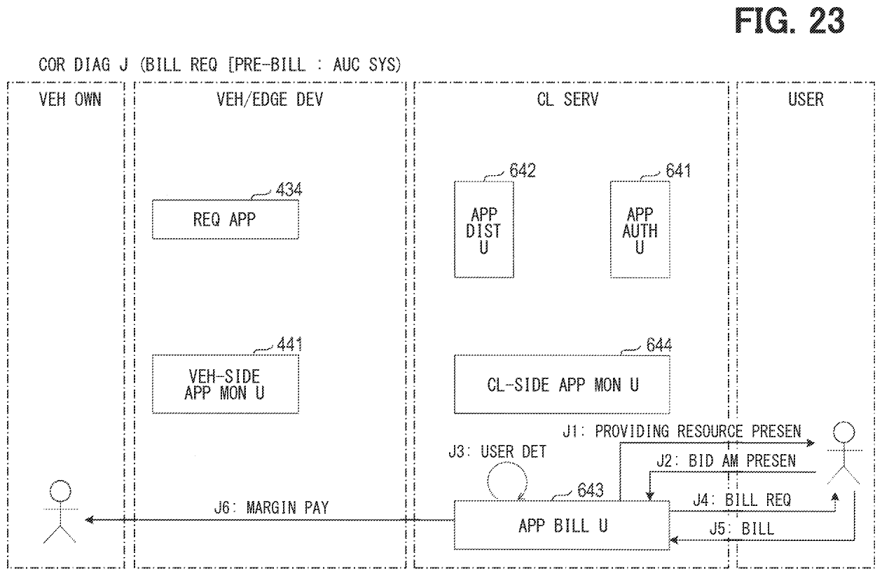

Next, an outline of the billing-request operation in the mobility IoT system 1 will be described with reference to FIGS. 22 and 23.

FIG. 22 shows the operation when billing is performed ex post facto according to the usage amount of resources required for execution of the request application.

As shown in FIG. 22, the vehicle-side application monitoring unit 441 monitors the request application when the processing status is “operation in processing” (at H1), and repeatedly transmits the information obtained by monitoring, that is, the processing status notification indicating the processing status to the cloud server 5 (at H2).

The cloud side application monitoring unit 644 updates the processing status DB according to the content of the received processing status notification (at H3).

When the check-out processing trigger is input (at H4), the application billing unit 643 calculates billing information and margin information by referring to the processing status DB and the like (at H5). The check-out process trigger may be automatically generated at a preset timing (for example, every month), or may be generated by an instruction from an administrator who manages the cloud server 5.

The application billing unit 643 executes the billing request to the user based on the generated billing information and the financial institution information registered in the user DB (at H6), and confirms the billing from the user (at H7).

The application billing unit 643 makes the compensation payment to the vehicle owner based on the generated margin information and the financial institution information registered in the owner DB (at H8).

FIG. 23 shows the operation when pre-billing is performed by auction or the like before the request application is actually executed. Here, it may be assumed that auction targets include rare vehicles, special vehicles, vehicles equipped with special exterior devices, vehicles equipped with high-grade edge devices 3, and vehicles equipped with special applications. Also, the planning of the auction is carried out at the suggestion of the vehicle owner, the manager of the cloud server 5, or the like.

As shown in FIG. 23, the application billing unit 643 presents the user with available resources as an auction target (at J1). The resource targeted for this auction corresponds to the specific resource in the embodiments.

The user submits a bid price for the resource that he/she wants to use (at J2).

The application billing unit 643 determines a user according to the bid amount, and generates billing information and margin information according to the bid amount (at J3).

Thereafter, in the same manner as H6 to H8, billing request to the user (at J4), confirmation of the billing from the user (at J5), and compensation payment to the vehicle owner (at J6) are performed.

In the case of pre-billing, a function of collecting an additional fee or forcibly stopping the request application may be provided when resources are used in excess of the conditions presented at the time of bidding. Also, the bid price presented by the user in J2 corresponds to the bid information in this disclosure, and the user determined in J3 corresponds to the authorized user in this disclosure.

### 5. Effects

The above-described embodiments provides the following effects.

(5a) In the mobility IoT system 1, when both the vehicle state and the ECU state are normal, it is possible to cause the edge-equipped vehicle to execute the request application using resources provided in the edge-equipped vehicle.

For example, when the condition for determining that the vehicle state is normal includes a low load with sufficient processing capacity of the resource, the resource of the edge-equipped vehicle, which is an idle asset, can be effectively used.

In addition, instead of determining that the vehicle condition is normal when the load is low, it may determines that the vehicle condition is normal when there is no emergency event such as when the automatic braking is activated or when a collision occurs. In this case, even in a state in which the processing capacity of the resource is low, the state becomes “lending allowed”, and the request application can be distributed. For example, it is possible to distribute a request application that has a function of retrieving vehicle travel data regardless of the load state of the vehicle.

(5b) The mobility IoT system 1 charges the resource user and pays the compensation to the resource provider. Therefore, a new business can be provided such that the needs of vehicle owners who want to make a profit by effectively using the resources of edge-equipped vehicles match the needs of program developers who want to use the processing power of the resources even if they charge a fee.

(5c) In the mobility IoT system 1, the processing load of the cloud server 5 can be distributed to edge-equipped vehicles, so the cost required for operating the cloud server 5 can be reduced.

(5d) In the mobility IoT system 1, the resource allocation and the billing amount for the user are changed according to the priority of the request application. Therefore, it is possible to realize flexible operation according to the request of the user who provides the request application.

(5e) In the mobility IoT system 1, by changing the billing amount for the user according to the overall margin of resources in the entire system, the usage of resources by the user may be guided to the time zone when the margin of resource is large.

### 6. Other Embodiments

Although the embodiments of the embodiments have been described above, the embodiments is not limited to the embodiments described above, and various modifications can be made to implement the embodiments.

(6a) In the embodiments, one cloud server 5 collects information about the vehicle and the edge device 3, distributes the request application, bills, and so on. Alternatively, the functions of the cloud server 5 may be provided by a plurality of servers.

(6b) The usage of resources may be configured to be grasped using not only direct information such as the CPU usage rate and usage time, the memory usage rate and usage time, and the external device usage rate and usage time, but also indirect information such as when the vehicle is stopped.

(6c) The control units 34, 53 and techniques thereof described in the embodiments may be implemented by a dedicated computer provided by configuring a processor and a memory programmed to execute one or more functions embodied by a computer program. Alternatively, the control units 34, 53 and techniques thereof described in the embodiments may be implemented by a dedicated computer provided by configuring the processor with one or more dedicated hardware logic circuits. Alternatively, the control units 34, 53 and techniques thereof described in the embodiments may be implemented by one or more dedicated computers configured with a combination of a processor and a memory programmed to execute one or more functions, and a processor configured with one or more hardware logic circuits. The computer program may also be stored in a computer readable non-transitory tangible storage medium as computer executable instructions. The method of implementing the function of each part included in the control units 34, 53 does not necessarily include software, and all the functions may be implemented using one or more pieces of hardware.

(6d) Multiple functions of one component in the above embodiment may be implemented by multiple components, or a function of one component may be implemented by multiple components. Multiple functions of multiple components may be implemented by one component, or one function implemented by multiple components may be implemented by one component. A part of the configuration in the above embodiments may be omitted. At least a part of the configuration in one embodiment may be added to or substituted for the configuration of another embodiment.

(6e) In addition to the mobility IoT system as the mobility service providing system described above, the embodiments can also be implemented in various forms such as a cloud server and an edge device as server devices constituting the mobility service providing system, a program for causing a computer to function as the server device or the edge device, a non-transitory tangible storage medium such as a semiconductor memory in which this program is recorded, and the like.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A mobility service providing method for providing a service for causing at least one edge-equipped vehicle, which is a vehicle equipped with an edge device that communicates with a server device, to execute a request application, which is an application registered in the server device, the mobility service providing method comprising:
determining, by the server device, as a distribution target vehicle, the at least one edge-equipped vehicle that satisfies a distribution requirement set in association with the request application;
distributing, by the server device, the request application to the edge device mounted on the distribution target vehicle;
executing, by the edge device, the request application distributed from the server device using a resource provided in the at least one edge-equipped vehicle;
transmitting, by the edge device, resource information related to an usage status of the resource for the executing of the request application to the server device; and
generating, by the server device, first compensation information for charging to an user who requests a processing of the request application and second compensation information for paying to an owner of the at least one edge-equipped vehicle who provides the resource, according to the resource information transmitted from the edge device.

2. The mobility service providing method according to claim 1, wherein:
the at least one edge-equipped vehicle includes a plurality of edge-equipped vehicles;
the determining of the distribution target vehicle by the server device includes: accumulating vehicle information repeatedly transmitted from each of the plurality of edge-equipped vehicles in association with each of the plurality of edge-equipped vehicles; and
determining whether each of the plurality of edge-equipped vehicles satisfies the distribution requirement, by referring to an accumulated vehicle information.

3. The mobility service providing method according to claim 1, wherein:
the distribution requirement includes at least one of static information of the at least one edge-equipped vehicle, dynamic information of the at least one edge-equipped vehicle, static information of the edge device, and dynamic information of the edge device;
the static information does not change over time; and
the dynamic information changes over time.

4. The mobility service providing method according to claim 3, wherein:
the dynamic information of the at least one edge-equipped vehicle includes at least one of vehicle interior environment information, vehicle exterior environment information, vehicle state information, device usage information, function usage information, occupant information, and time-series data information.

5. The mobility service providing method according to claim 1, wherein:
the request application includes at least one of a vehicle-related job and a non-vehicle-related job;
the vehicle-related job is meaningful to be executed in the at least one edge-equipped vehicle; and
the non-vehicle-related job is other than the vehicle-related job.

6. The mobility service providing method according to claim 1, wherein:
the request application includes at least one of resident type request application and a complete type request application;
the resident type request application is an application for repeatedly executing a routine job; and
the complete type request application is an application for executing a non-routine job whose process ends when an operation result is output.

7. The mobility service providing method according to claim 1, further comprising:
setting a priority for the request application;
allocating, by the edge device, the resource according to the priority; and
changing, by the server device, the first compensation information according to the priority.

8. The mobility service providing method according to claim 1, further comprising:
grasping, by the server device, the usage status of the resource for all the edge-equipped vehicles capable of receiving the distributing of the request application;
and changing, by the server device, the first compensation information according to overall margin of the resource.

9. The mobility service providing method according to claim 1, wherein:
the distribution requirement includes whether a processing capacity provided by the resource of the at least one edge-equipped vehicle has a processing capacity necessary for executing the request application.

10. The mobility service providing method according to claim 1, wherein:
the distribution requirement includes whether the resource of the at least one edge-equipped vehicle includes an external device necessary for executing the request application.

11. The mobility service providing method according to claim 1, wherein:
the distribution requirement includes whether the resource of the edge device of the at least one edge-equipped vehicle is disposed in a low load state.

12. The mobility service providing method according to claim 1, wherein:
the edge device has at least a lending allowed state and a lending not allowed state as a lending base status;
the lending allowed state is a state when both the at least one edge-equipped vehicle and the edge device are normal; the lending not allowed state is a state when at least one of the at least one edge-equipped vehicle and the edge device is in an anomaly state; and
the executing of the request application distributed from the server device by the edge device is performed when the lending base status is in the lending allowed state.

13. The mobility service providing method according to claim 1, further comprising:
receiving, by the server device, bid information for using a specific resource from a plurality of users;
determining, by the server device, an authorized user who is one of the plurality of users and permitted to use the specific resource, based on the bid information;
determining, by the server device, the first compensation information for charging to the authorized user, based on the bid information; and
determining, by the server device, the second compensation information for paying to the owner as a provider who provides the specific resource, based on the first compensation information.

14. A mobility service providing system comprising:
a server device; and
an edge device mounted on a vehicle and communicating with the server device, wherein:
the vehicle equipped with the edge device is defined as an edge-equipped vehicle;
the edge device includes:
an application execution unit configured to execute a request application distributed from the server device using a resource provided in the edge-equipped vehicle; and
a status notification unit configured to grasp resource information related to an usage status of the resource for executing the request application, and to transmit the resource information to the server device; and
the server device includes:
an application distribution unit configured to determine the edge-equipped vehicle that satisfies a distribution requirement set in association with the request application as a distribution target vehicle, and to distribute the request application to the edge device mounted on the distribution target vehicle; and
an application billing unit configured to generate first compensation information for charging to an user who requests a processing of the request application and second compensation information for paying to an owner of the edge-equipped vehicle who provides the resource, according to the resource information transmitted from the edge device.

15. A server device providing a mobility service providing system together with an edge device that: is mounted on a vehicle which is defined as an edge-equipped vehicle; executes a request application distributed from the server device using a resource provided in the vehicle; and transmits resource information related to an usage status of the resource for executing the request application to the server device, the server device comprising:
an application distribution unit configured to determine the edge-equipped vehicle that satisfies a distribution requirement set in association with the request application as a distribution target vehicle, and to distribute the request application to the edge device mounted on the distribution target vehicle; and
an application billing unit configured to generate first compensation information for charging to an user who requests a processing of the request application and second compensation information for paying to an owner of the edge-equipped vehicle who provides the resource, according to the resource information transmitted from the edge device.

16. An edge device mounted on a vehicle which is defined as an edge-equipped vehicle and providing a mobility service providing system together with a server device that: determines the edge-equipped vehicle, which satisfies a distribution requirement set in association with a request application, as a distribution target vehicle; distributes the request application to the edge device mounted on the distribution target vehicle; and generates first compensation information for charging to an user who requests a processing of the request application and second compensation information for paying to an owner of the edge-equipped vehicle who provides a resource, according to the resource information transmitted from the edge device, the edge device comprising:
an application execution unit configured to execute the request application distributed from the server device, using the resource provided in the edge-equipped vehicle; and
a status notification unit configured to grasp the resource information relating to an usage status of the resource for executing the request application and notify the server device of the resource information.

17. A non-transitory computer readable storage medium comprising instructions being executed by a computer, the instructions including a method for causing the computer equipped in a server device providing a mobility service providing system together with an edge device that: is mounted on a vehicle defined as an edge-equipped vehicle; executes a request application distributed from the server device using a resource provided in the vehicle; and transmits resource information related to an usage status of the resource for executing the request application to the server device, to function as:
an application distribution unit configured to determine the edge-equipped vehicle that satisfies a distribution requirement set in association with the request application as a distribution target vehicle, and to distribute the request application to the edge device mounted on the distribution target vehicle; and
an application billing unit configured to generate first compensation information for charging to an user who requests a processing of the request application and second compensation information for paying to an owner of the edge-equipped vehicle who provides the resource, according to the resource information transmitted from the edge device.
